(19) United States
(12) Patent Application Publication
(10) Pub. No.: US 2025/0384319 A1
(43) Pub. Date: Dec. 18, 2025

(54) QUANTUM COMPUTING APPARATUS WITH PHOTONS AND ATOMIC MEMORIES

(71) Applicants: Eun OH, Richardson, TX (US); BOARD OF REGENTS, THE UNIVERSITY OF TEXAS SYSTEM, Austin, TX (US); KENNESAW STATE UNIVERSITY RESEARCH AND SERVICE FOUNDATION, INC., Kennesaw, GA (US)

(72) Inventors: Shengwang DU, Richardson, TX (US); Eun OH, Richardson, TX (US); Xuanying LAI, Richardson, TX (US); Jianming WEN, Richardson, TX (US)

(73) Assignees: Eun OH, Richardson, TX (US); BOARD OF REGENTS, THE UNIVERSITY OF TEXAS SYSTEM, Austin, TX (US); KENNESAW STATE UNIVERSITY RESEARCH AND SERVICE FOUNDATION, INC., Kennesaw, GA (US)

(21) Appl. No.: 18/879,001

(22) PCT Filed: Jun. 26, 2023
(86) PCT No.: PCT/US2023/069089

§ 371 Date: Dec. 26, 2024

Related U.S. Application Data
(60) Provisional application No. 63/355,617, filed on Jun. 26, 2022.

(51) Int. Cl. G06N 10/40; G06N 10/20; G06N 10/60

(52) U.S. Cl. CPC G06N 10/40; G06N 10/20; G06N 10/60

(57) ABSTRACT

Systems and methods to perform quantum computing using a Rydberg blockade effect for a photon-photon nonlinear interaction at the single photon level that realizes a controlled-phase (CP) gate between control and target qubits that are encoded in the polarizations of a photon pair. Electromagnetically induced transparency (EIT) is used to write the photonic quantum state into the ground states of an ensemble of atoms. Then a controlled phase shift is induced via combination of Rabi flopping/oscillations and a Rydberg blockade effect. Then EIT transfers the quantum state with the conditional phase shift back from the ensemble of atoms to the photon pair, resulting in a CP gate. Waveplates before and after the ensemble of atoms can convert the CP gate to a CNOT gate. Distributed quantum computing is realized by transporting the photons between spatially separated quantum memories (i.e., ensemble of atoms).

### CROSS-REFERENCE TO RELATED APPLICATION

This application claims the benefit of U.S. Provisional Patent Application No. 63/355,617 titled “Quantum Computing Apparatus with Photons and Atomic Memories” and filed on Jun. 26, 2022, the disclosure of which is hereby incorporated by reference in its entirety.

### ACKNOWLEDGEMENT OF GOVERNMENT SUPPORT

This invention was made with government support under grant number DES00022069 awarded by the Department of Energy, grant number FA9550-22-1-0043 awarded by AFOSR, and grant number CNS 2114076 awarded by the National Science Foundation. The government has certain rights in the invention.

### BACKGROUND

### 1. Field

The present disclosure relates generally to systems and methods for quantum computing using photon-atom interaction. In at least one example, the present disclosure relates to a system configured to perform quantum computing using a Rydberg blockade effect in an ensemble of atoms to realize a controlled-phase (CP) gate.

### 2. Discussion of Related Art

A quantum computer is a computer that exploits quantum mechanical phenomena.

Classical physics cannot explain the operation of these quantum devices, and a scalable quantum computer could perform some calculations exponentially faster than any modern “classical” computer. For example, a large-scale quantum computer could break widely used encryption schemes and aid physicists in performing physical simulations. Quantum algorithms for certain problems have significantly lower time complexities than corresponding known classical algorithms. Notably, quantum computers are believed to be able to solve many problems quickly that no classical computer could solve in any feasible amount of time—a feat known as “quantum supremacy.” To become practical, quantum computing faces several challenges, such as decoherence and scalable quantum interactions, and thus improved quantum computing devices are desired.

Different from bits 0 and 1 in a classical digital computer, a quantum bit (i.e. qubit) is generally a superposition of two discrete states |0 [symbol] and |1 [symbol] and multiple qubits can be quantum mechanically entangled. When measuring a qubit, the result is a probabilistic output of a classical bit. If a quantum computer manipulates the qubit in a particular way, wave interference effects can amplify the desired measurement results. The design of quantum algorithms involves creating procedures that allow a quantum computer to perform calculations efficiently and quickly.

Analogous to digital gates in a classical computer, a universal quantum computer also requires a set of basic quantum gates to operate its qubits. For example, a set of universal gates can be rotation operators, phase shift, and controlled-NOT (CNOT) gates.

Three leading candidates for quantum computer platforms are superconducting circuits, trapped ions, and neutral atom arrays. Even though there are ongoing efforts to address various challenges, all these systems have strong interactions with environmental and control noises that introduce decoherence and a limited lifetime for quantum computation.

In contrast to the above three candidates for quantum computers, photons are well decoupled from the background, travel at the highest speed in the universe and can be precisely controlled in picosecond time resolution routinely in lab. The challenge with using photons to encode qubits in a quantum computer is that photon-photon interactions are typically weak, making two-qubit quantum gates difficult. Though manipulating photonic single qubits is straightforward with linear optics including wave plates, mirrors, and beam splitters, the path toward universal quantum computing faces a great challenge due to the lack of efficient optical nonlinearity at a single-photon level. The widely used scheme with linear optics, making use of probabilistic measurement-induced effective “nonlinearity”, is practically not efficient for large-scale implementation because it requires an enormous amount of ancilla photons and computational time.

Accordingly, improved techniques and devices are desired to achieve efficient optical nonlinearity at a single-photon level as the basis for optical quantum computing.

It is with these observations in mind, among others, that various aspects of the present disclosure were conceived and developed.

### BRIEF SUMMARY

The presently disclosed technology addresses the foregoing problems by providing systems and methods for providing efficient optical nonlinearity at a single-photon level as the basis for optical quantum computing. In some examples, a method to perform a quantum computing operation comprises: initializing a quantum memory (QM) including a plurality of atoms in a first quantum state of the QM; mapping a photonic quantum state of a photon pair to the QM to cause the QM to transition from the first quantum state to a second quantum state, the photon pair including a first photon and a second photon that propagate along respective optical paths through the QM; and inducing a phase shift on the second quantum state, the phase shift based on a Rydberg blockade and conditional on the photonic quantum state.

In some instances, the first quantum state includes each of the plurality of atoms in a first ground state, and the second quantum state includes an entangled state that is a superposition of states in which one of the plurality of atoms is in a second ground state with all other atoms of the plurality of atoms in the first ground state, when at least one photon of the photon pair has a first polarization.

In some examples, the method includes inducing the phase shift by using the Rydberg blockade to induce the phase shift on a first set of atoms in a first optical path of the first photon or on a second set of atoms in a first optical path of the second photon, wherein, the first set of atoms and the second set of atoms are respective subsets of the plurality of atoms of the QM, the second set of atoms is spaced from the first set of atoms, and the second set of atoms is within a proximity to the first set of atoms to enable the Rydberg blockade between the second set of atoms and the first set of atoms.

In some instances, the phase shift is induced by: (i) inducing a first Rabi oscillation on the first set of atoms, the first Rabi oscillation being induced from the second ground state to a Rydberg state using an Nπ pulse with N being an odd integer, (ii) inducing a second Rabi oscillation on the second set of atoms, the second Rabi oscillation being induced between the second ground state and the Rydberg state, when the Rydberg state is not shifted due to the Rydberg blockade, using an 2Mπ pulse with M being an odd integer, and (iii) inducing a third Rabi oscillation on the first set of atoms, the third Rabi oscillation induced from the Rydberg state to the second ground state using a Pπ pulse with P being an odd integer.

In some instances, the first quantum state includes each of the plurality of atoms in a first ground state, when the photonic quantum state includes no photon having a first polarization, the second quantum state is the same state as the first quantum state, when the photonic quantum state includes one photon having the first polarization, the second quantum state is a first entangled state in which one of the plurality of atoms is in a second ground state with all other atoms of the plurality of atoms being in the first ground state, and when the photonic quantum state includes two photons having the first polarization, the second quantum state is a second entangled state in which two of the plurality of atoms are in the second ground state with all other atoms of the plurality of atoms being in the first ground state.

In some examples, the method includes inducing the phase shift by inducing a Rabi oscillation on a set of atoms of the plurality of atoms, wherein, the set of atoms is in an optical path of both the first photon and the second photon, and the Rabi oscillation is induced between the second ground state and a Rydberg state using an Nπ pulse with N being an even integer, such that, for both the first entangled state and the second entangled state, the Rabi oscillation concludes with a complete Rabi flopping cycle with the set of atoms substantially returning from the Rydberg state to the second ground state.

In some instances, the photonic quantum state is encoded in respective polarizations of the first photon and the second photon, a state of a control qubit is encoded in a polarization of the first photon, and a state of a target qubit is encoded in a polarization of the second photon.

In some examples, or each photon of the photon pair, a first polarization is sent along a first optical path through the QM, and a second polarization is sent along a second optical path that circumvents the QM, and the method further comprises recombining the first optical path and the second optical path to direct the first polarization and the second polarization along a same optical path for each photon of the photon pair, the first optical path and the second optical path recombined using a polarizing beam splitter (PBS).

In some instances, the first optical path of the first photon overlaps the first optical path of the second photon.

In some examples, the first optical path of the first photon is spaced from the first optical path of the second photon, and the first optical path of the first photon is within a proximity to the first optical path of the second photon to enable the Rydberg blockade.

In some instances, the mapping of the photonic quantum state to the QM is performed using electromagnetically induced transparency to couple the photonic quantum state with the QM.

In some examples, a two-qubit controlled-phase (CP) gate operation is performed on the photon pair due to interactions with the QM to yield a conditional phase on the photon pair due to the interactions with the QM being conditional on the photonic quantum state.

In some instances, the method includes converting the CP gate operation to a controlled-not (CNOT) gate operation by applying waveplates to the second photon before the QM and after the QM.

In some examples, the waveplates after the QM include a first quarter-waveplate oriented at a 45 degree angle and a second quarter-waveplate oriented at a 90 degree angle with respect to a direction of a second polarization of each of the photon pair.

In some instances, the method includes generating a Greenberger-Horne-Zeilinger (GHZ) state among a plurality of photons including a first photon and other photons, the first photon having a polarization that encodes a control qubit, the other photons having respective polarizations that encode corresponding target bits; and using at least one QM to perform respective CNOT gate operations between the first photon and each of the other photons.

In some examples, the method includes providing a universal set of gates for quantum computing to enable a plurality of operations on a quantum computer by providing photonic circuits routing optical paths among QMs, the QMs providing two-qubit controlled-phase (CP) gate operations or two-qubit controlled-not (CNOT) gate operations, the photonic circuits including waveguides having path lengths providing phase shifts, the photonic circuits including waveplates to provide single-qubit Pauli gate operations and phase-shift gate operations.

In some instances, the method includes arranging the photonic circuits and the QMs to perform a quantum algorithm.

In some examples, the quantum algorithm is Shor's algorithm for finding prime factors of an integer, or the quantum algorithm is a quantum phase estimation algorithm, or the quantum algorithm solves in polynomial time a classically nondeterministic polynomial (NP)-hard problem.

The presently disclosed technology addresses the foregoing problems by providing systems for providing efficient optical nonlinearity at a single-photon level as the basis for optical quantum computing. In some examples, a quantum apparatus comprises: a photon pair including a first photon and a second photon, the photon pair encoding a photonic quantum state in a first polarization of the first photon and in a second polarization of the second photon; a quantum memory (QM) including a plurality of atoms initialized in a first quantum state of the QM, the QM including a first optical path of the first photon along which the first polarization of the first photon propagates and a first optical path of the second photon along which the second polarization of the second photon propagates; and a controller configured to control a plurality of laser fields, the plurality of laser fields including a Rydberg field, wherein the controller is configured to: initialize the QM in a first quantum state, map the photonic quantum state of the photon pair to the QM to cause the QM to transition from the first quantum state to a second quantum state, and induce a phase shift on the second quantum state, the phase shift based on a Rydberg blockade and conditional on the photonic quantum state.

In some examples, the first quantum state includes each of the plurality of atoms in a first ground state, and the second quantum state includes an entangled state that is a superposition of states in which one of the plurality of atoms is in a second ground state with all other atoms of the plurality of atoms in the first ground state when at least one photon of the photon pair has the first polarization.

In some instances, the controller is configured to induce the phase shift by using the Rydberg blockade to induce the phase shift on a first set of atoms in the first optical path of the first photon or on a second set of atoms in the first optical path of the second photon, the first set of atoms and the second set of atoms are respective subsets of the plurality of atoms of the QM, the second set of atoms is spaced from the first set of atoms, and the second set of atoms is within a proximity to the first set of atoms to enable the Rydberg blockade between the second set of atoms and the first set of atoms.

In some examples, the controller is configured to induce the phase shift by: inducing a first Rabi oscillation on the first set of atoms, the first Rabi oscillation being induced from the second ground state to a Rydberg state using an Nπ pulse with N being an odd integer, inducing a second Rabi oscillation on the second set of atoms, the second Rabi oscillation being induced between the second ground state and the Rydberg state, when the Rydberg state is not shifted due to the Rydberg blockade, using a 2Mπ pulse with M being an odd integer, and inducing a third Rabi oscillation on the first set of atoms, third Rabi oscillation induced from the Rydberg state to the second ground state using a Pπ pulse with P being an odd integer.

In some instances, the first quantum state includes each of the plurality of atoms in a first ground state, when the photonic quantum state includes no photon having the first polarization, the second quantum state is a same state as the first quantum state, when the photonic quantum state includes one photon having the first polarization, the second quantum state is a first entangled state in which one of the plurality of atoms is in a second ground state with all other atoms of the plurality of atoms being in the first ground state, and when the photonic quantum state includes two photons having the first polarization, the second quantum state is a second entangled state in which two of the plurality of atoms is in the second ground state with all other atoms of the plurality of atoms being in the first ground state.

In some examples, the controller is configured to induce the phase shift by inducing a Rabi oscillation on a set of atoms of the plurality of atoms, the set of atoms is in an optical path of both the first photon and the second photon, and the Rabi oscillation is induced between the second ground state and a Rydberg state using an Nπ pulse with N being an even integer, such that, for both the first entangled state and the second entangled state, the Rabi oscillation concludes with a complete Rabi flopping cycle with the set of atoms substantially returning from the Rydberg state to the second ground state.

In some instances, the photonic quantum state is encoded in respective polarizations of the first photon and the second photon, a state of a control qubit is encoded in a polarization of the first photon, and a state of a target qubit is encoded in a polarization of the second photon.

In some examples, for each photon of the photon pair, the first polarization is sent along the first optical path through the QM and the second polarization is sent along a second optical path that circumvents the QM.

In some instances, the first optical path of the first photon overlaps the first optical path of the second photon.

In some examples, a first polarizing beam splitter (PBS) operable to recombine the first optical path of the first photon and a second optical path of the first photon; and a second PBS operable to recombine the first optical path of the second photon and a second optical path of the second photon.

In some instances, the first optical path of the first photon is spaced from the first optical path of the second photon; and the first optical path of the first photon is within a proximity to the first optical path of the second photon to enable the Rydberg blockade.

In some examples, the controller is configured to map the photonic quantum state to the QM using electromagnetically induced transparency.

In some instances, the quantum apparatus is configured to perform a two-qubit controlled-phase-(CP) gate operation on the photon pair using interactions with the QM, resulting in a conditional phase on the photon pair due to said interactions with the QM being conditional on a two-qubit quantum state of the photon pair.

In some examples, the quantum apparatus is configured to perform a two-qubit controlled-not (CNOT) gate operation by applying waveplates to the second photon before the QM and after the QM.

In some instances, the waveplates after the QM include a first quarter-waveplate oriented at a 45 degree angle and a second quarter-waveplate oriented at a 90 degree angle with respect to a direction of a second polarization of each of the photon pair.

In some examples, the quantum system generates a Greenberger-Horne-Zeilinger (GHZ) state among a plurality of photons comprising a first photon and other photons, the first photon having a polarization that encodes a control qubit, the other photons having respective polarizations that encode corresponding target bits, and use one or more QMs to perform respective CNOT gate operations between the first photon and each of the other photons.

In some instances, a quantum system comprises a plurality of quantum apparatuses as described above that include a plurality of the QMs described above, and photonic pathways are arranged among the plurality of the QMs directing photons along the pathways to provide distributed quantum computing.

In some examples, the quantum system includes that the photonic pathways are arranged among the plurality of the QMs to provide a universal set of gate quantum computing gates including at least one two-qubit controlled-phase (CP) gate or at least one two-qubit controlled-not (CNOT) gate, at least one single-qubit Pauli gate, and at least one single-qubit phase-shift gate.

In some instances, the photonic pathways are arranged among the plurality of the QMs to perform a quantum algorithm.

In some examples, the quantum algorithm is Shor's algorithm for finding prime factors of an integer, or the quantum algorithm is a quantum phase estimation algorithm, or the quantum algorithm solves in polynomial time a classically nondeterministic polynomial (NP)-hard problem.

The presently disclosed technology addresses the foregoing problems by providing systems for providing efficient optical nonlinearity at a single-photon level as the basis for optical quantum computing. In some examples, a quantum computer comprises a plurality of single-qubit gates, each gate of the plurality of single-qubit gates comprising a waveplate oriented with a fast axis at a respective angle; and a controlled plurality of controlled-phase gates, each controlled-phase gate comprising: a path for a photon pair including a first photon and a second photon, the photon pair encoding a photonic quantum state in a first polarization of the first photon and in a second polarization of the second photon; and a quantum memory (QM) including a plurality of atoms initialized in a first quantum state of the QM, the QM including a first optical path of the first photon along which the first polarization of the first photon propagates and a first optical path of the second photon along which the second polarization of the second photon propagates; and a controller configured to control a plurality of laser fields, the plurality of laser fields including a Rydberg field, wherein the controller is configured to: initialize the QM in a first quantum state, map the photonic quantum state of the photon pair to the QM to cause the QM to transition from the first quantum state to a second quantum state, and induce a phase shift on the second quantum state, the phase shift based on a Rydberg blockade and conditional on the photonic quantum state.

The foregoing is intended to be illustrative and is not meant in a limiting sense. Many features of the embodiments may be employed with or without reference to other features of any of the embodiments. Additional aspects, advantages, and/or utilities of the presently disclosed technology will be set forth in part in the description that follows and, in part, will be apparent from the description, or may be learned by practice of the presently disclosed technology.

### BRIEF DESCRIPTION OF THE DRAWINGS

The foregoing summary, as well as the following detailed description, will be better understood when read in conjunction with the appended drawings. For the purpose of illustration, there is shown in the drawings certain embodiments of the disclosed subject matter. It should be understood, however, that the disclosed subject matter is not limited to the precise embodiments and features shown. The accompanying drawings, which are incorporated in and constitute a part of this specification, illustrate an implementation of systems and methods consistent with the disclosed subject matter and, together with the description, serve to explain advantages and principles consistent with the disclosed subject matter, in which:

FIG. 1A shows an example of a schematic diagram of a first architecture of a controlled phase (CP) gate, in accordance with certain embodiments of the disclosure;

FIG. 1B shows an example of atomic ensembles of the first architecture of the CP gate, in accordance with certain embodiments of the disclosure;

FIG. 1C shows an example of another atomic ensemble of the first architecture of the CP gate, in accordance with certain embodiments of the disclosure;

FIG. 1D shows an example of a laser pulse sequence with respect to atomic transitions of the first architecture of the CP gate, in accordance with certain embodiments of the disclosure;

FIG. 2A shows an example of a schematic diagram of a second architecture of the CP gate, in accordance with certain embodiments of the disclosure;

FIG. 2B shows an example of a laser pulse sequence with respect to atomic transitions of the second architecture of the CP gate, in accordance with certain embodiments of the disclosure;

FIG. 3A shows an example of a quantum circuit diagram for converting a CP gate to a CNOT gate, in accordance with certain embodiments of the disclosure;

FIG. 3B shows an example of a plot of CNOT gate performance as a function of efficiency, in accordance with certain embodiments of the disclosure;

FIG. 4A shows an example of a quantum circuit diagram for generating an N qubit Greenberger-Horne-Zeilinger (GHZ) state, in accordance with certain embodiments of the disclosure;

FIG. 4B shows an example of a plot of fidelity and efficiency of the GHZ state as a function of efficiency, in accordance with certain embodiments of the disclosure;

FIG. 4C shows an example of a plot of fidelity and efficiency of the GHZ state as a function of the number N of qubits, in accordance with certain embodiments of the disclosure;

FIG. 5A shows an example of a flow diagram of a method of performing the CP gate, in accordance with certain embodiments of the disclosure;

FIG. 5B shows an example of a flow diagram of a step of applying a laser field to a Rydberg transition for a second architecture of the CP gate, in accordance with certain embodiments of the disclosure;

FIG. 5C shows an example of a flow diagram of a sequence of laser field to Rydberg transitions for a first architecture of the CP gate, in accordance with certain embodiments of the disclosure;

FIG. 5D shows an example of a flow diagram for converting the CP gate to a CNOT gate, in accordance with certain embodiments of the disclosure;

FIG. 6A shows an example of a schematic diagram of quantum computer based on the CP gate, in accordance with certain embodiments of the disclosure;

FIG. 6B shows an example of a schematic diagram of another implementation of a quantum computer based on the CP gate, in accordance with certain embodiments of the disclosure;

FIG. 7A shows an example of a quantum circuit diagram of a quantum half adder, in accordance with certain embodiments of the disclosure;

FIG. 7B shows an example of a quantum circuit diagram of a Toffoli gate, in accordance with certain embodiments of the disclosure;

FIG. 7C shows an example of a quantum logic gates, in accordance with certain embodiments of the disclosure;

FIG. 7D shows an example of a quantum circuit diagram of Shor's algorithm, in accordance with certain embodiments of the disclosure;

FIG. 7E shows an example of a quantum circuit diagram of a quantum phase estimation algorithm, in accordance with certain embodiments of the disclosure;

FIG. 8A shows an example of Zeeman levels and transitions thereon for the second architecture of the CP gate, in accordance with certain embodiments of the disclosure;

FIG. 8B shows an example of an optical diagram for the second architecture of the CP gate, in accordance with certain embodiments of the disclosure;

FIG. 9A shows an example of a level diagram and transitions thereon for the second architecture of the CP gate, in accordance with certain embodiments of the disclosure;

FIG. 9B shows an example of a first optical diagram for the second architecture of the CP gate, in accordance with certain embodiments of the disclosure;

FIG. 9C shows an example of a second optical diagram for the second architecture of the CP gate, in accordance with certain embodiments of the disclosure;

FIG. 10 shows an example of a schematic diagram for a loss model of the first architecture of the CP gate, in accordance with certain embodiments of the disclosure;

FIG. 11 shows an example of a schematic diagram for a loss model of the second architecture of the CP gate, in accordance with certain embodiments of the disclosure; and

FIG. 12 shows an example of a schematic diagram for a computational system, in accordance with certain embodiments of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

### I. Terminology

The phraseology and terminology employed herein are for the purpose of description and should not be regarded as limiting. For example, the use of a singular term, such as, “a” is not intended as limiting of the number of items. Also, the use of relational terms such as, but not limited to, “top,” “bottom,” “left,” “right,” “upper,” “lower,” “down,” “up,” and “side,” are used in the description for clarity in specific reference to the figures and are not intended to limit the scope of the presently disclosed technology or the appended claims. Further, it should be understood that any one of the features of the presently disclosed technology may be used separately or in combination with other features. Other systems, methods, features, and advantages of the presently disclosed technology will be, or become, apparent to one with skill in the art upon examination of the figures and the detailed description. It is intended that all such additional systems, methods, features, and advantages be included within this description, be within the scope of the presently disclosed technology, and be protected by the accompanying claims.

Further, as the presently disclosed technology is susceptible to embodiments of many different forms, it is intended that the present disclosure be considered as an example of the principles of the presently disclosed technology and not intended to limit the presently disclosed technology to the specific embodiments shown and described. Any one of the features of the presently disclosed technology may be used separately or in combination with any other feature. References to the terms “embodiment,” “embodiments,” and/or the like in the description mean that the feature and/or features being referred to are included in, at least, one aspect of the description. Separate references to the terms “embodiment,” “embodiments,” and/or the like in the description do not necessarily refer to the same embodiment and are also not mutually exclusive unless so stated and/or except as will be readily apparent to those skilled in the art from the description. For example, a feature, structure, process, step, action, or the like described in one embodiment may also be included in other embodiments but is not necessarily included. Thus, the presently disclosed technology may include a variety of combinations and/or integrations of the embodiments described herein. Additionally, all aspects of the present disclosure, as described herein, are not essential for its practice. Likewise, other systems, methods, features, and advantages of the presently disclosed technology will be, or become, apparent to one with skill in the art upon examination of the figures and the description. It is intended that all such additional systems, methods, features, and advantages be included within this description, be within the scope of the presently disclosed technology, and be encompassed by the claims.

Any term of degree such as, but not limited to, “substantially,” as used in the description and the appended claims, should be understood to include an exact, or a similar, but not exact configuration. For example, “a substantially planar surface” means having an exact planar surface or a similar, but not exact planar surface.

The term “coupled” is defined as connected, whether directly or indirectly through intervening components, and is not necessarily limited to physical connections. The connection can be such that the objects are permanently connected or releasably connected. The terms “comprising,” “including” and “having” are used interchangeably in this disclosure. The terms “comprising,” “including” and “having” mean to include, but not necessarily be limited to the things so described. The term “real-time” or “real time” means substantially instantaneously.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

### II. General Architecture

The systems disclosed herein improve upon previous techniques by providing efficient optical nonlinearity at a single-photon level as the basis for optical quantum computing.

As discussed above, quantum computing devices based on superconducting circuits, trapped ions, and neutral atom arrays have the advantage of strong interactions, which is helpful in devising two-qubit gates, but is disadvantageous due to strong interactions with the environment introducing decoherence.

In contrast, optical quantum computing devices based on photons are well decoupled from the background, travel at the highest speed in the universe, and can be precisely controlled in picosecond time resolution routinely in the lab. The challenge with using photons to encode qubits in a quantum computer is that photon-photon interactions are typically weak, making two-qubit quantum gates difficult. The methods and devices disclosed herein overcome this limitation using the Rydberg blockade to mediate photon-photon interactions at the single photon level by inducing a controlled phase shift. Accordingly, the methods and devices disclosed herein provide improved techniques and devices to achieve efficient optical nonlinearity at a single-photon level as the basis for optical quantum computing.

Atomic ensemble Rydberg state mediated nonlinearity can be used to realize photon-photon interaction gates, by converting between photonic states and collective Rydberg polariton states. The methods and devices disclosed herein provide a universal quantum computing scheme based on photonic polarizations and efficient atomic-ensemble ground-state QMs. To introduce nonlinear interaction between two qubits, the photonic qubit states are converted into atomic-ensemble-based states in a quantum memory (QM), and a two-qubit controlled-phase (CP) gate is implemented using the Rydberg blockade effect. This scheme enables a quantum computer with spatially distributed components in which the photons encoded with the quantum states can be propagated from one QM performing a CP gate to another spatial distant QM performing another CP gate. Additionally or alternatively, this scheme enables networking multiple remotely distributed local quantum computers by transporting photons via waveguides (e.g., long haul optical fibers) between the remotely distributed local quantum computers.

The methods and devices disclosed herein are illustrated using two schemes of CP gate implementation as non-limiting examples of CP gates. The methods and devices disclosed herein are further illustrated using an example in which the CP gates are used to implement a non-limiting example of a CNOT gate. The performance as a function of QM efficiency is presented for the CNOT gate. The methods and devices disclosed herein are illustrated using a non-limiting example of generating an N-photon Greenberger-Horne-Zeilinger (GHZ) state based on CNOT gates and linear optics, demonstrating the scalability of the methods and devices disclosed herein. The methods and devices disclosed herein are illustrated using a non-limiting example of a QM implementation with an atomic ensemble with losses and imperfections. The methods and devices disclosed herein are illustrated using a non-limiting example of distributed quantum computing.

### CP Gate

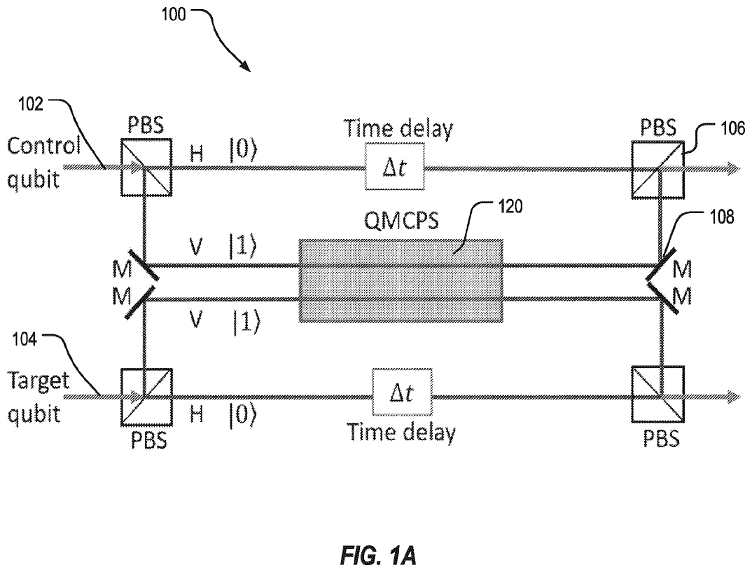

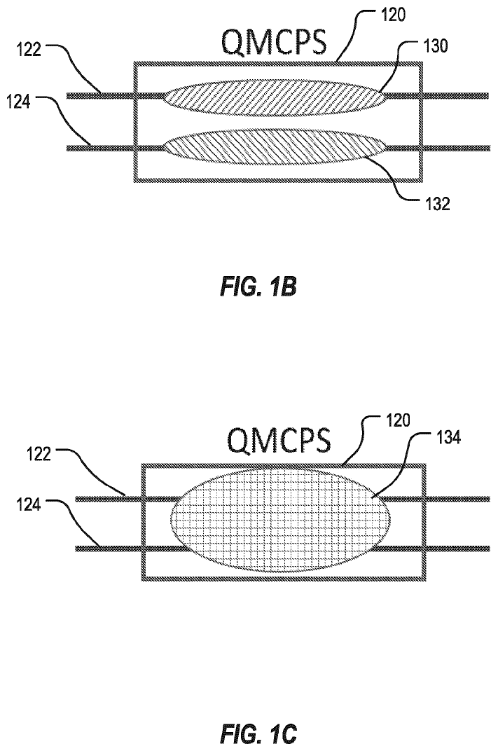

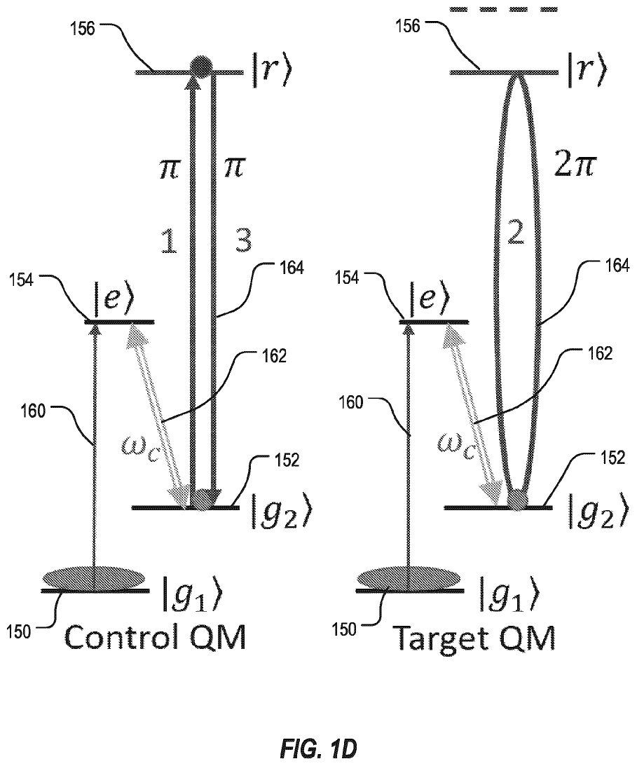

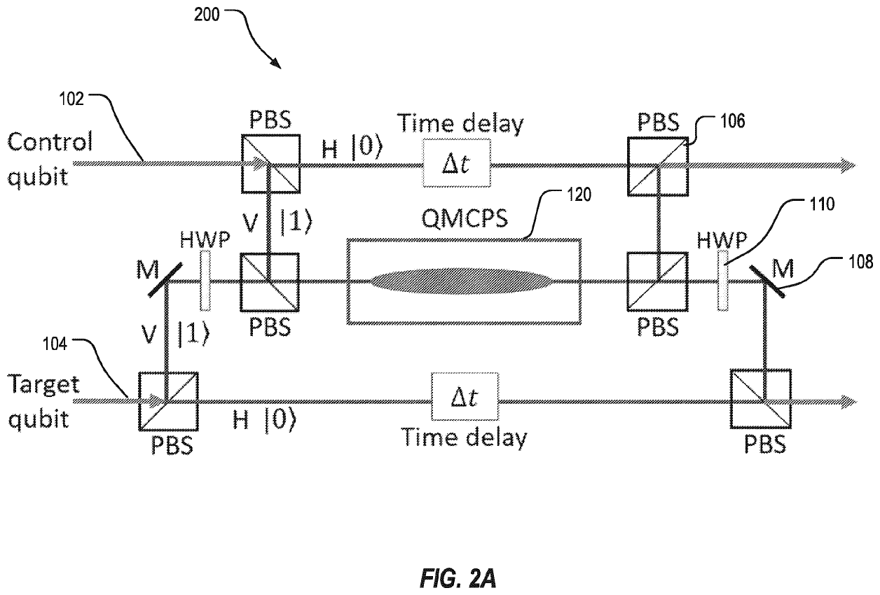

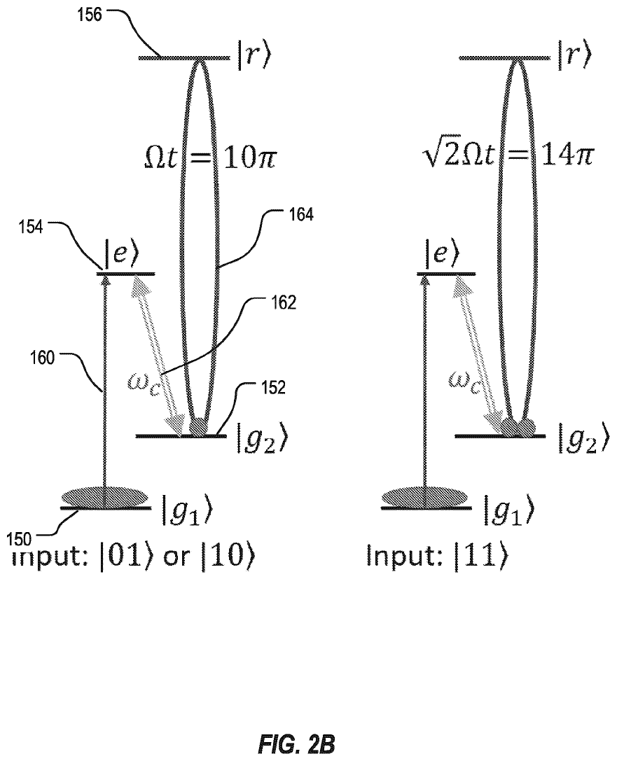

FIGS. 1A and 2A illustrate two non-limiting examples of a controlled phase (CP)-gate using an atomic ensemble to provide a quantum memory (QM) controlled phase shift (QMCPS) unit 120. Two different schemes are presented for the two-qubit CP gate with photonic qubits and atom-ensemble QM Rydberg blockade. In the first scheme, the control and target photon-atom QM modes are spatially separated and their Rydberg excitations are applied sequentially. In the second scheme, the two modes overlap spatially and require only a single Rydberg excitation pulse.

FIGS. 1A-1D illustrate a first architecture 100 of the photon-atom QM-mediated CP gate realization. The first architecture 100 uses the Rydberg blockade effect, which has the advantage of being less sensitive to the Rydberg state dephasing. As shown in FIG. 1A, the single photon computational basis is encoded onto the two orthogonal polarizations: |0 [symbol] =|H [symbol] (horizontal) and |1 [symbol] =|V [symbol] (vertical). After passing through two polarizing beam splitters (PBSs) 106, the polarizations of the control photon 102 and target photon 104 are spatially separated into four paths. The two V-polarized photon modes are injected into a QM-controlled phase shift (QMCPS) atomic ensemble 120. The QMCPS 120 comprises two closely placed atomic ensembles. The first atomic ensemble 130 overlaps path 122 of the control photon 102 and the second atomic ensemble 132 overlaps path 124 of the target photon 104. That is, each of the two closely placed atomic ensembles corresponds to one photon mode, as shown in FIG. 1B. With respect to dipole interactions that mediate the Rydberg blockade, the two closely placed atomic ensembles are considered to be one big atomic ensemble 134 with two nonoverlapping photon modes, as shown in FIG. 1C.

After the QMCPS operation (discussed below with reference to FIG. 1D), the photons 102 and 104, which were temporarily stored in the atomic ensembles as polaritons, are read out of the QMCPS 120 and combined with their H modes after another two PBSs 106. Mirrors 108 are used to direct the photons 102 and 104 along their respective paths. The time delays Δt in the two H polarization paths are used to compensate the QMCPS operation time.

When the input photon state is |00 [symbol] , where the first is the control qubit and the second is the target qubit, both photons pass through the two H spatial paths without any interaction and the output is still |00 [symbol] .

When the input states are |01 [symbol] , |10 [symbol] , and |11 [symbol] , the QMCPS operation is illustrated in FIG. 1D. A QM with electromagnetically induced transparency (EIT) can involve three atomic states: two long-lived hyperfine ground states |g₁ [symbol] 150 and |g₂ [symbol] 152 and one excited state |e [symbol] 154. A Rydberg state |r [symbol] 156 with a large principal quantum number is used for the Rydberg blockade. The qubit photons are on resonance at the transition |g₁ [symbol] ↔|e [symbol] 160. When the QM is in idle, all the atoms are prepared in the state |g₁ [symbol] with presence of a control (ω_{c}) laser beam on resonance to the transition |g₂ [symbol] ↔|e [symbol] 162. As a V-polarized qubit photon wave packet enters the QM, the control laser is switched off to convert the photonic state into the following entangled QM state

$$\vert QM 〉 = \frac{1}{\sqrt{{N}_{a}}} [ {e}^{i {ϕ}_{1}} \vert {g}_{2} {g}_{1} {g}_{1} … {g}_{1} {g}_{1} 〉 + {e}^{i {ϕ}_{2}} \vert {g}_{1} {g}_{2} {g}_{1} … {g}_{1} {g}_{1} 〉 + … + {e}^{i {ϕ}_{{N}_{a}}} \vert {g}_{1} {g}_{1} … {g}_{1} {g}_{2} 〉 ] ,$$

where Nₐ is the number of atoms; ϕⱼ=\vec{k}·\vec{rⱼ}, with \vec{k} the qubit photon wave vector, is the photon mode propagation phase at position \vec{rⱼ} and stores the photon momentum information. This QM writing operation is performed on both memories (i.e., the first atomic ensemble 130 and the second atomic ensemble 132), in a similar manner to how CP gates are implemented in neutral atom quantum computing schemes. To attain the CP gate, the following three pulses are applied sequentially: i) a π Rydberg excitation pulse on resonance at the transition |g₂ [symbol] ↔|r [symbol] to excite the control memory state |QM [symbol] to the following collective Rydberg state:

$$\vert QMR 〉 = \frac{1}{\sqrt{{N}_{a}}} [ {e}^{i {ϕ}_{1}} \vert {rg}_{1} {g}_{1} … {g}_{1} {g}_{1} 〉 + {e}^{i {ϕ}_{2}} \vert {g}_{2} {rg}_{1} … {g}_{1} {g}_{1} 〉 + … + {e}^{i {ϕ}_{{N}_{a}}} \vert {g}_{1} {g}_{1} … {g}_{1} r 〉 ] ;$$

ii) a 2π pulse to the resonant transition |g₂ [symbol] ↔|r [symbol] on the target memory, and iii) a second π pulse to bring the control memory back to |QM [symbol] . After these three pulses, the control laser beams are switched back on to both memories and the QM state(s) is(are) then converted back to V-polarized photon(s).

With the input state |01 [symbol] , all atoms in the control memory are in the state |g₁ [symbol] without Rydberg excitation such that the target memory returns to its |QM [symbol] with a negative sign after the 2π pulse. This negative sign is imprinted to the readout photon state, i.e., |01 [symbol] →−|01 [symbol] . With the input |0 [symbol] , there is no excitation in the target memory and the control memory state obtains a negative sign after two π pulses: |10 [symbol] →−|10 [symbol] . In the case with the input |11 [symbol] , both memories are excited into the state |QM [symbol] . After the first π pulse, the control memory is excited to its Rydberg state |QMR [symbol] , which induces a blue energy shift for the target memory Rydberg state |r [symbol] due to the dipole-dipole interaction and prevents Rydberg excitation in the target memory. This blockade effect makes the 2π pulse on the target memory unable to complete the excitation cycle, unable to gain a negative phase. After the second π pulse, the control memory returns to its |QM [symbol] with a negative sign. Overall, |11 [symbol] →→−11 [symbol] is obtained for the readout photons. In terms of the two-qubit basis |00 [symbol] , |01 [symbol] , |10 [symbol] , |11 [symbol] , the above CP gate can be described by a 4×4 matrix

$$CP = [ \begin{matrix}1 & 0 & 0 & 0 \\ 0 & - 1 & 0 & 0 \\ 0 & 0 & - 1 & 0 \\ 0 & 0 & 0 & - 1\end{matrix} ] .$$

As an alternative scheme, FIGS. 2A-2B illustrate the second CP gate architecture 200. In contrast to the first architecture 100, which had two closely placed QM atomic ensembles or two overlapping photon modes, the second architecture 200 has only one ensemble capable of storing two photonic modes which overlap in space. These two modes can be two orthogonal polarizations or two momentum modes. For the purpose of illustration, the second architecture 200 is illustrated using the non-limiting example of two polarization modes that have maximum spatial overlap in the single QM atomic ensemble. This example is non-limiting. For example, the polarization modes can be converted into momentum modes.

As illustrated in FIG. 2A, the V polarization of the target photon is transformed into H polarization with a half-wave plate (HWP) and is then combined with the V polarization of the control photon at a PBS 106 (which is reversed at output PBS 106). After the photon(s) is(are) stored inside the QM, one single-atom Ωt=10π Rydberg excitation pulse is applied, with Ω being the single-atom Rabi frequency and t the pulse length. In the case with the input |01 [symbol] or |10 [symbol] , only one atom is excited to |g₂ [symbol] 152 as shown in FIG. 2B and the overall QM state is described by

$$\vert QMR 〉 = \frac{1}{\sqrt{{N}_{a}}} [ {e}^{i {ϕ}_{1}} \vert {rg}_{1} {g}_{1} … {g}_{1} {g}_{1} 〉 + {e}^{i {ϕ}_{2}} \vert {g}_{1} {rg}_{1} … {g}_{1} {g}_{1} 〉 + … + {e}^{i {ϕ}_{{N}_{a}}} \vert {g}_{1} {g}_{1} … {g}_{1} r 〉 ] .$$

Hence, the 10π Rydberg excitation pulse results in a negative sign to the QM state as well as to the retrieved photon. For the input |11 [symbol] case, two atoms are excited to |g₂ [symbol] and the QM state becomes

$$\vert QM 2 〉 = \sqrt{\frac{2 ! ( {N}_{a} - 2 ) !}{{N}_{a} !}} {e}^{i {ϕ}_{12}} \vert {g}_{2} {g}_{2} {g}_{1} … {g}_{1} {g}_{1} 〉 + {e}^{i {ϕ}_{13}} \vert {g}_{2} {g}_{1} {g}_{2} … {g}_{1} {g}_{1} 〉 + … + {e}^{i {ϕ}_{{N}_{a} - 1 {N}_{a}}} \vert {g}_{1} {g}_{1} … {g}_{1} {g}_{2} {g}_{2} 〉$$

with ϕᵢⱼ=ϕᵢ+ϕⱼ. For brevity, the above equation is abbreviated as |QM2 [symbol] =|g₂g₂ [symbol] . With the same 10π Rydberg excitation pulse applied to two atoms, the blockade mechanism leads to an oscillation between |g₂g₂ [symbol] and the symmetric Rydberg state 1/\sqrt{2}[|rg₂ [symbol] +|g₂r [symbol] ] with an effective Rabi frequency \sqrt{2}Ω. Accordingly, the Ωt=10π Rydberg excitation pulse is effectively enhanced as \sqrt{2}Ωt=10\sqrt{2}π14π by returning the QM state to |QM2 [symbol] with a r-phase shift. That is, |11 [symbol] →−|11 [symbol] for the readout photons. In this way, the same CP gate

[symbol]

$$CP = [ \begin{matrix}1 & 0 & 0 & 0 \\ 0 & - 1 & 0 & 0 \\ 0 & 0 & - 1 & 0 \\ 0 & 0 & 0 & - 1\end{matrix} ]$$

is obtained as in first architecture 100. The technical advantages between the first architecture 100 and the second architecture 200 become apparent in the sense that the latter configuration not only improves Rydberg blockade effect due to the perfect spatial overlap of the two photonic modes, but requires only a single excitation pulse instead of three. It is noted that, the difference between 10\sqrt{2}π and 14π induces only an average CP gate infidelity (error rate) of 0.001, which may not be the limiting factor of the gate fidelity. The fidelity of a real CP gate may be limited by other factors such as control noise and system fluctuation.

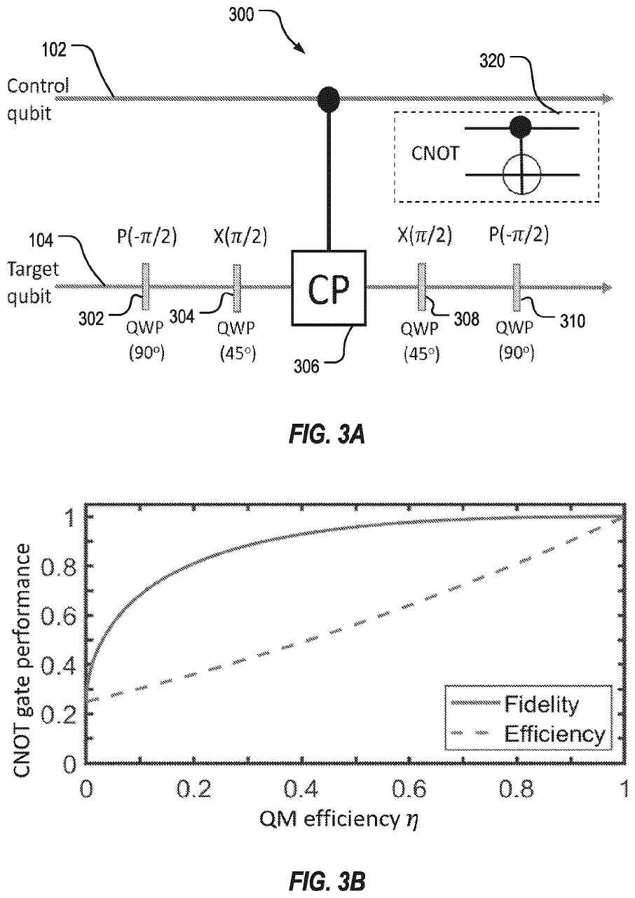

Referring now to FIGS. 3A-3B, the CP gate is transformed into a standard CNOT gate with additional target single-qubit operations, as represented by the quantum circuit of FIG. 3A. The single-qubit operations P(−π/2) and X(π/2) are realized using waveplates. Here, P(−π/2) is given by

$$P ( - \frac{π}{2} ) = [ \begin{matrix}1 & 0 & 0 & 0 \\ 0 & - i & 0 & 0 \\ 0 & 0 & - 1 & 0 \\ 0 & 0 & 0 & - i\end{matrix} ] .$$

$$X ( π / 2 ) is given by$$

$$X ( \frac{π}{2} ) = [ \begin{matrix}1 & - i & 0 & 0 \\ - i & 1 & 0 & 0 \\ 0 & 0 & 1 & - i \\ 0 & 0 & - i & 1\end{matrix} ] .$$

For a photonic polarization qubit, an arbitrary unitary transformation can be realized with a combination of HWPs and quarter-wave plates (QWPs) by properly aligning their slow-fast axes. FIG. 3A shows that the path of the target qubit 104 before the CP gate 306 includes a QWP 302 oriented at a 90° angle and a QWP 304 oriented at a 45° angle to realize the P(−π/2) and X(π/2) operations, respectively. After the CP gate 306, the path of the target qubit 104 includes a QWP 308 oriented at a 45° angle and a QWP 310 oriented at a 90° angle to realize the X(π/2) and P(−π/2) operations, respectively. The matrix representations of HWP and QWP are summarized by Table 1. The waveplates can be realized using free-space optics or using birefringent waveguides with tilted axis for the birefringent modes.

TABLE 1
matrix representations of half-wave plate (HWP) and quarter-wave plate (QWP)
operations

| | |
|---|---|
| Linear polarizer, transmission axis at θ w.r.t. horizontal | $[ \begin{matrix}{cos}^{2} θ & cos θ sin θ \\ cos θ sin θ & {sin}^{2} θ\end{matrix} ]$ |
| Quarter-wave plate, fast axis at ±45° | $\frac{1}{\sqrt{2}} [ \begin{matrix}1 & ∓ i \\ ∓ i & 1\end{matrix} ]$ |
| Quarter-wave plate, fast axis at θ w.r.t. horizontal | $[ \begin{matrix}{cos}^{2} θ + i {sin}^{2} θ & ( 1 - i ) sin θ cos θ \\ ( 1 - i ) sin θ cos θ & {sin}^{2} θ + i {cos}^{2} θ\end{matrix} ]$ |
| Half-wave plate, fast axis at θ w.r.t. horizontal | $[ \begin{matrix}cos 2 θ & sin 2 θ \\ sin 2 θ & - cos 2 θ\end{matrix} ]$ |

The single-qubit phase gate P(−π/2) is realized by a QWP whose fast axis is aligned along the V-polarization direction. The X(π/2) rotation gate is achieved by a QWP whose fast axis is aligned at 45° with respect to the H-polarization direction. Following the quantum circuit is obtained

$$CNOT = [ \begin{matrix}1 & 0 & 0 & 0 \\ 0 & 1 & 0 & 0 \\ 0 & 0 & 0 & 1 \\ 0 & 0 & 1 & 0\end{matrix} ] .$$

The QM efficiency, which can be modeled as photonic loss, is an important factor in determining the CNOT gate performance. In FIG. 3(b), the CNOT gate fidelity and efficiency are plotted as a function of QM efficiency η. While the fidelity remains as high as >0.9 as the QM efficiency η drops to 0.33, the gate efficiency decreases to 0.44. This marks a significant difference between photonic and other quantum computing platforms. For the trapped-ion and atom-array systems, their gate fidelities depend strongly on the control noise as it reduces a pure qubit state into a mixed one. In the photon-atom hybrid system, the coupling between the qubit Hilbert space and environment is only caused by the loss, and the lost photons disappear into the environment but are not detected by single-photon counters. As a result, the QM loss does not affect the fidelity much, but reduces the state generation efficiency as a cost. For η>0.4, the gate fidelity is not sensitive to the QM efficiency because of the post-selection renormalization.

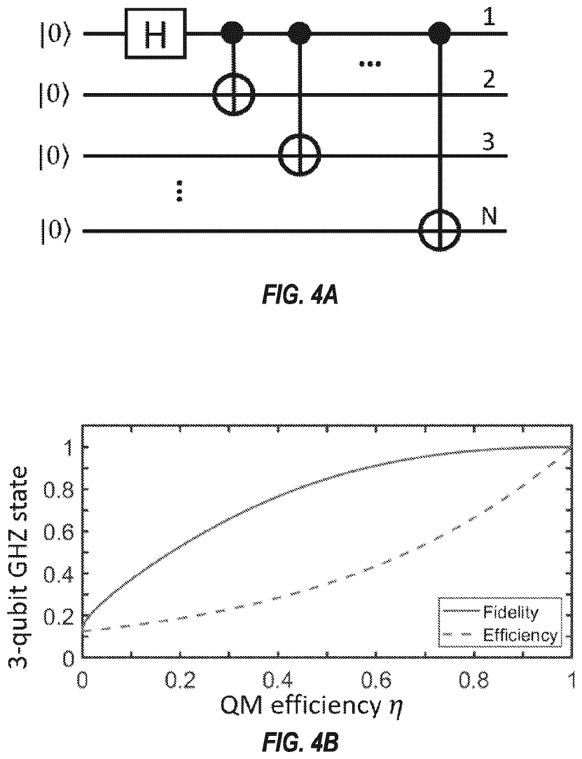

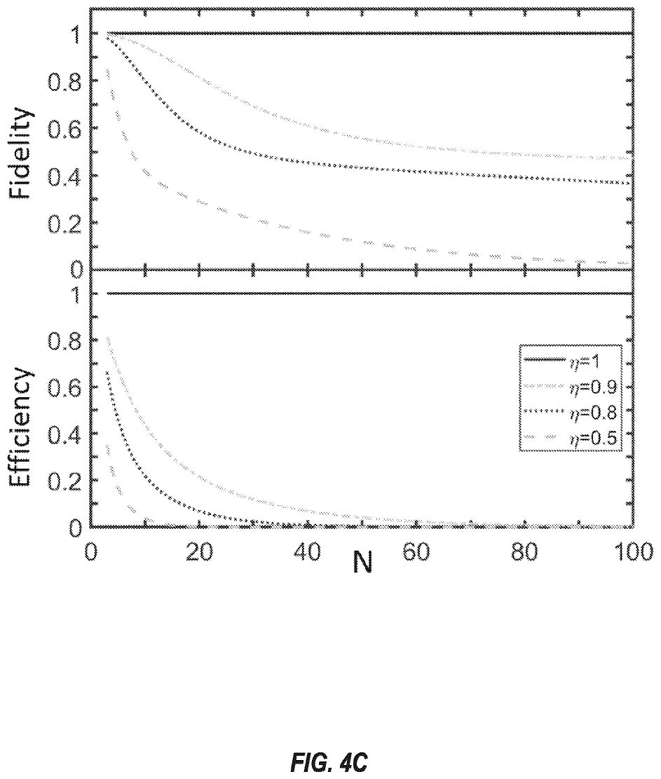

FIGS. 4A-4C illustrate an example of scalability application in which QM-mediated CNOT gates and linear optics are applied to generate an N-photon GHZ state, 1/\sqrt{2}[000 . . . [symbol] +|111 . . . [symbol] ]. FIG. 4A is the quantum circuit with the initial (input) unentangled state prepared as |000 . . . [symbol] , involving N−1 CNOT gates. The Hadamard (H) gate transforms the first qubit from |0 [symbol] to 1/\sqrt{2}[|0 [symbol] +|1 [symbol] ] and can be implemented by a HWP with its fast axis aligned at 22.5° to the H-polarization axis. FIG. 4A shows the quantum circuit for generating N-qubit GHZ state.

FIG. 4B shows the 3-qubit GHZ state fidelity and generation efficiency as a function of QM efficiency η. The fidelity and efficiency of yielding a three-photon GHZ state as a function of single QM efficiency η are given in FIG. 4B. A fidelity >0.9 is realized when η>0.58 where the state generation efficiency is 0.42.

FIG. 4C shows N-qubit GHZ state fidelity (top) and generation efficiency (bottom) as a function of N. The state fidelity and generation efficiency are shown as a function of N for different η in FIG. 4C, respectively. As can be seen, when N=100 a fidelity >0.47 is still achievable for η=0.9, but the generation efficiency reduces sharply as N increases.

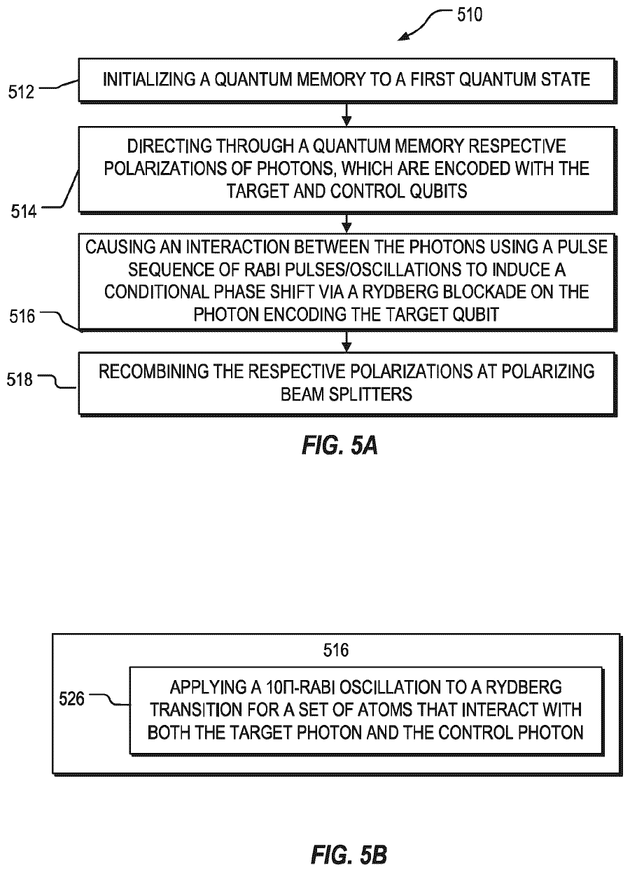

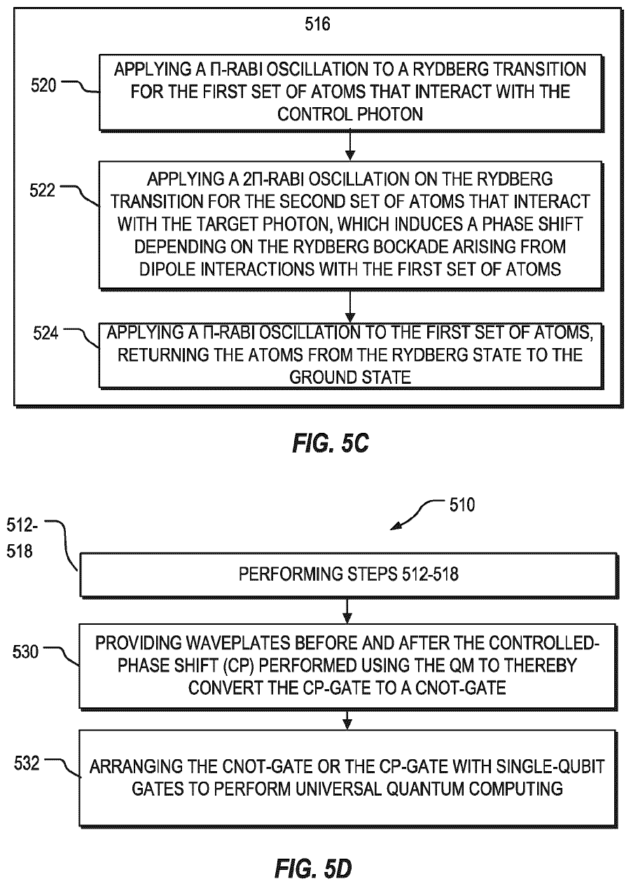

FIG. 5A shows a flow diagram of a method 510 for performing a quantum computing operation.

In step 512 of method 510, the quantum memory (QM) is initialized in the state.

$$\vert QM 〉 = \vert {g}_{2} {g}_{1} {g}_{1} … {g}_{1} {g}_{1} 〉$$

In step 514 of method 510, respective polarizations of the target and control photons are directed through the quantum memory (QM). The polarizations of the target and control photons are encoded with the target and control qubits.

In step 516 of method 510, an interaction is caused between the target and control photons. The interaction is caused using a pulse sequence of Rabi pulses/oscillations to induce a conditional phase shift via a Rydberg blockade on the photon encoding the target qubit. Different methods can be used to induce the conditional phase shift via a Rydberg blockade, as illustrated in the non-limiting example of the first architecture 100 and the second architecture 200.

In step 518 of method 510, the respective polarizations are recombined at polarizing beam splitters (PBSs).

FIG. 5B shows a flow diagram of step 516 in accordance with the second architecture 200. Step 516 includes step 526 in which a 10π-Rabi pulse is applied to the Rydberg transition for a set of atoms that interact with both the target photon and the control photon.

FIG. 5C shows a flow diagram of step 516 in accordance with the first architecture 100. In step 520 of step 516, a π-Rabi pulse is applied to a Rydberg transition for a first set of atoms 130 that interact with the control photon 102.

In step 522 of step 516, a 2π-Rabi oscillation is applied on the Rydberg transition for a second set of atoms 132 that interact with the target photon 104, which induces a phase shift depending on the Rydberg blockade arising from dipole interactions with the first set of atoms.

In step 524 of step 516, a π-Rabi pulse is applied to the first set of atoms 130, returning the atoms from the Rydberg state to the ground state.

FIG. 5D shows a flow diagram of method 510, which includes additional steps for performing universal quantum computing using the Rydberg blockade mediated CP gate.

Steps 512-518 are performed as discussed with reference to FIG. 5A.

In step 530 of method 510, waveplates are provided before and after the controlled-phase shift (CP) gate, converting the CP gate to a CNOT gate.

In step 532 of method 510, CNOT gates and/or the CP gates are arranged together with single-qubit gates to perform universal quantum computing. A universal gate set for universal quantum computing is provided by the combination of single-qubit gates (i.e., the Pauli gates Rx(θ), Ry(θ), Rz(θ) and the phase shift gate P(φ)) together with either the two-qubit CNOT gate or CP gate, as discussed in Williams, Colin P. (ed.), Explorations in Quantum Computing, 2^{nd} Ed., Texts in Computer Science, London: Springer (2011), which is incorporated herein by reference in its entirety.

The Pauli gates Rx(θ), Ry(θ), and Rz(θ) can be provided by wave plates as discussed above. The phase shift gate P(φ) can be provided by delay lines or generally propagating the photon along a path that results in a phase shift.

The universal quantum computing gate set provided by method 510 enables all possible quantum computing algorithms. This can be realized using a photonic circuit or free-space optics. In a free-space optics implementation, the path/direction of the photons can be controlled using mirrors (e.g., mirrors mounted on actuators or goniometers), such as micro-electro-mechanical systems (MEMS) mirrors. The path/direction of the photons can be controlled/steered using electro-optic modulators or acousto-optic modulators. In a free-space optics implementation, the waveplates can be free-space waveplates. The atomic ensembles can be atomic vapors. The atomic ensembles can be laser cooled and trapped in a magneto-optical trap (MOT). The atomic ensembles may be a solid-state system, such as embedded ions in a solid-state crystalline lattice. The atomic ensembles may be realized as a collection of quantum dots.

In a photonic circuit implementation, the photons will be guided along optical waveguides. The waveguides may have birefringent portions (e.g., with dimensions or material properties that result in different propagation constants for different polarization), which act as waveplates. The photonic circuits can include switches/routers that can be controlled to change which input waveguide is coupled to which output waveguide. For example, these can use fiber optic switches and routers.

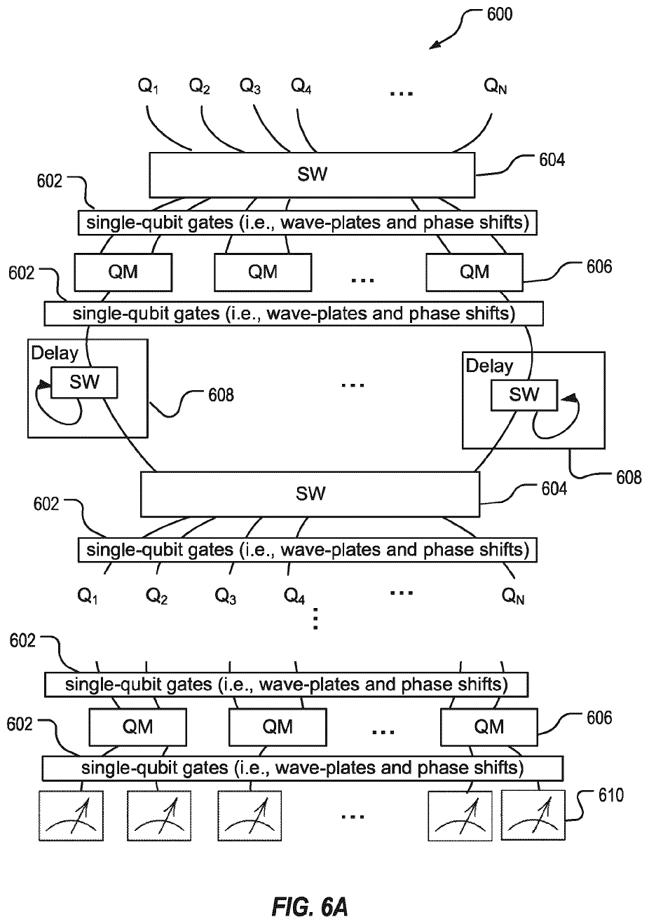

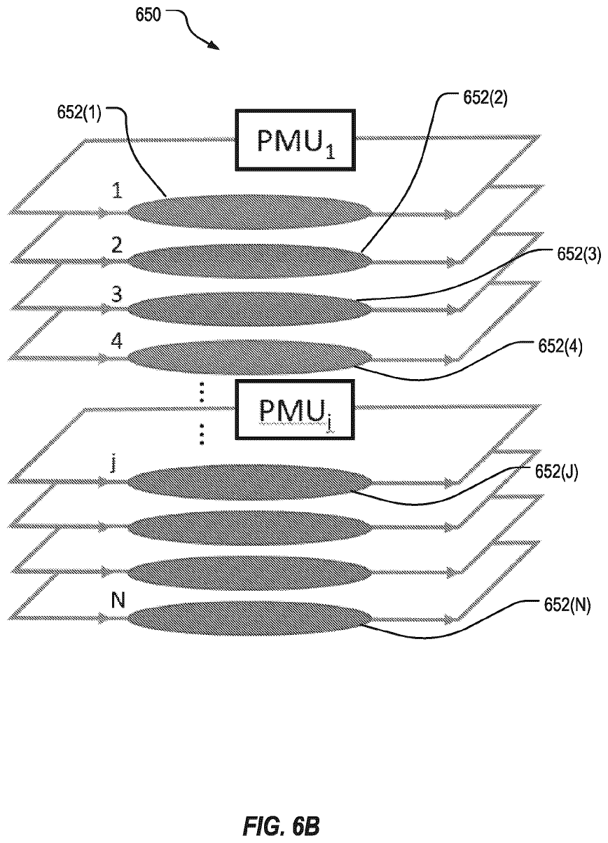

FIG. 6A shows a schematic diagram of a quantum computer 600 based on the QM 120, such as illustrated in FIGS. 1A and 2A. The quantum computer 600 starts with N qubits (i.e., Q₁, Q₂, Q₃, Q₄, . . . Q_{N}) are put into a switch (SW) 604. Next a series of single-qubits gates 602 are applied. The output qubits from the single-qubits gates 602 are applied to the QM 606 which apply the two-qubit CP gates. Next a series of single-qubits gates 602 are applied. The output qubits from the single-qubits gates 602 are applied to a series of delays 608. Here, the delays are represented as a switch that directs the photon in a loop which can continue indefinitely, or the switch can couple the photon out of the delay loop to the output of the delay 608. The delays can be circumvented by coupling the photon directly from the input to the output of the switch (SW).

The qubits from the delays 608 are input to a switch 604, and the outputs of the switch are input to a series of single-qubits gates 602. The output qubits from the single-qubits gates 602 can be applied to QMs 606, which apply the two-qubit CP gates, and so on and so forth. Eventually the qubits are applied to a series of measurements 610.

As discussed above, the QMs 606 are realized using an atomic ensemble that uses EIT to convert the photon to a polariton in the entangled superposition of ground states, and a Rydberg blockade is used to induce a conditional phase shift, as illustrated using the first architecture 100 or the second architecture 100. The switches 604 can be performed using fiber optic switches, MEMs switches, or other optical switches. The single-qubit gates 602 can be realized using waveplates. The measurements 610 can be realized using avalanche photodiodes or other optical detectors.

Now some details of the QM are discussed. As shown above, QMs are used for the proposed architectures, providing conversion interfaces between single-photon polarization qubits and atomic states. It is challenging to implement efficient QM with single atom or ion, while an atomic ensemble has a collective enhancement under the phase-matching condition. Among various schemes including photon echo and off-resonance Raman interaction, so far EIT ground-state QM with laser-cooled atoms has demonstrated the highest efficiency (η>85%) for single photon polarization qubits with a fidelity of more than 99%. For a single polarization channel, the memory efficiency can be as high as 90.6%. A typical bandwidth of EIT quantum memory is about MHz, which is determined by the atomic optical depth and control laser intensity. While the non-limiting examples disclosed herein are illustrated for the case of polarization qubits, QMs for other degrees of freedoms, such as time bins and orbital angular momentum can alternatively be used.

It is noted that a combination of an efficient QM with photonic schemes disclosed herein can be implemented with slightly modifications using alkali atoms. For heavy alkali atoms widely used for laser cooling and trapping, such as rubidium (Rb) and cesium (Cs), their Rydberg interaction distance can be >40 μm for a large principal quantum number (n≥200). The previously demonstrated efficient QM requires a large optical depth (OD>100) achieved with an atomic ensemble length of about 1.0 cm, which certainly exceeds the Rydberg blockade distance. An atomic ensemble with a length of 40 m can be obtained by loading laser-cooled atoms into an optical dipole trap, but the resulting OD would be only about 0.4. A possible solution to enhance OD, while maintaining free-space-like accessibility, is to put the Rydberg-blockade-distance-limited atomic ensemble into a bad-cavity with a finesse [symbol] =800, which leads to an enhancement factor of [symbol] /π=255 for the effective OD:

$${OD}_{c} = \frac{π}{} {OD}_{0}$$

where OD₀ is the free-space, single-pass optical depth. The above estimation is based on the typical atomic density (1.2×10¹⁷ m⁻³) in a dark-line two-dimensional magneto-optical trap with a temperature of 20-100 μK. If a colder atomic ensemble or a dilute Bose-Einstein condensate is loaded with a density of 1.0×10¹⁸ m⁻³ into the same cavity, the required Rydberg blockade distance is immediately reduced to 4 μm, which is more accessible to the existing Rydberg (n≤100) excitation techniques. The QM efficiency depends on the cavity-enhanced effective OD, the atomic ground-state coherence time, and the atomic density induced loss (in high-density regime). Trapping hundreds of microscopic atomic ensembles in optical tweezer arrays can be used for atomic-ensemble based Rydberg qubits. Atom chip technique may be another solution to prepare single or array of atomic ensembles.

FIG. 6B shows a local quantum computer 650 in which multiple atomic ensembles 652(1), 652(2), 652(3), 652(4), . . . , 652(J), . . . , 652(N) are coupled via dipole-dipole interactions, such that any one of the atomic ensembles can be used to induce a conditional phase shift in another of the atomic ensembles via a Rydberg blockade. The photons can be circulated back to interact multiple times. Each of these loops can be controlled to delay which photon interacts with which of the other photons.

The photon-atom hybrid scheme provides a natural network interface for realizing distributed quantum computing. The device and methods disclosed herein are illustrated using two non-limiting configurations of “distributed” quantum computing. In the first configuration, as described above, the quantum circuit elements are spatially distributed and connected via optical modes (e.g., using free-space optics or photonic circuits). Thus, the hybrid photon-atom scheme can be used to build a “distributed” quantum computer whose components are remotely located. In this configuration, a quantum computing operation or task is nonlocally distributed.

The second configuration uses networking remotely distributed local quantum computers. For example, a certain non-limiting scheme can be used to construct a time-line local quantum computer by recycling the QMs, similar to those platforms with trapped ions and neutral atoms. FIG. 6B illustrates such an example. FIG. 6B illustrates schematics such as an N-qubit quantum computer structure with a one-dimensional (or two-dimensional) array of N QM atomic ensembles. For each QM, its readout photon is sent back to the QM after a programmable unitary transformation—a polarization manipulation unit (PMU), which can be realized by a combination of HWPs, QWPs, and other linear optics. The nonlinear controlled gate interaction between any two-qubit memories can be mediated by the Rydberg blockade effect. In this non-limiting configuration, only a single two-qubit gate is performed at a given time to avoid multiple simultaneous two-qubit gates from interfering with each other.

The timeline programmable depth, or the effective coherence time, of such a quantum computer is limited by the QM efficiency. Assuming the overall acceptable efficiency is ηₜ and QM efficiency is η=90%, the number of programmable steps is determined by ηₜ/ln(η)=22. To achieve more than 100 steps requires a higher QM efficiency of more than 98%. Different from the platforms with trapped single ions and neutral atoms whose coherence limits the computation duration, in the scheme the computation time is only limited by the photon loss, but not by the QM lifetime as it can be recycled and only requires time to complete a CP operation. As such, a local quantum computer has a natural efficient built-in photon-atom interface, networking more than one local quantum computers with photonic links will lead to distributed quantum computing. The methods and devices disclosed herein bridge the gap between the field of quantum computing and quantum networks, which have been largely isolated due to a lack of protocol for networking distributed quantum computers. The methods and devices disclosed herein provide a natural quantum network interface between flying photons and local atomic nodes.

The methods and devices disclosed herein have the benefit of incorporating the already established photonic linear manipulation and neutral atom nonlinear Rydberg interaction, encompassing building blocks not only for quantum computers, but also extending its capability to quantum networks. An attractive feature of this idea is that it can be spatially and temporally distributed. The methods and devices disclosed herein offer scalability for both single-qubit and two-qubit controlled gates.

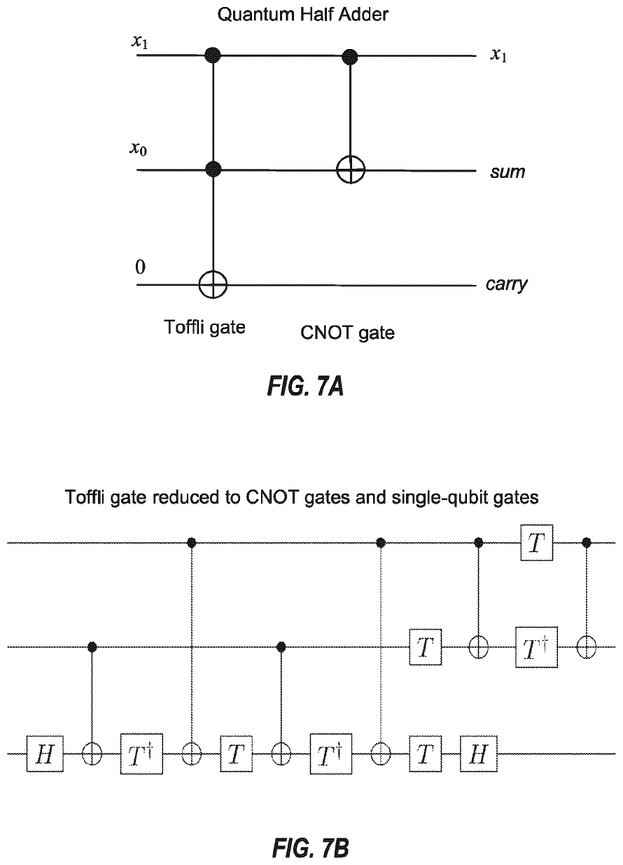

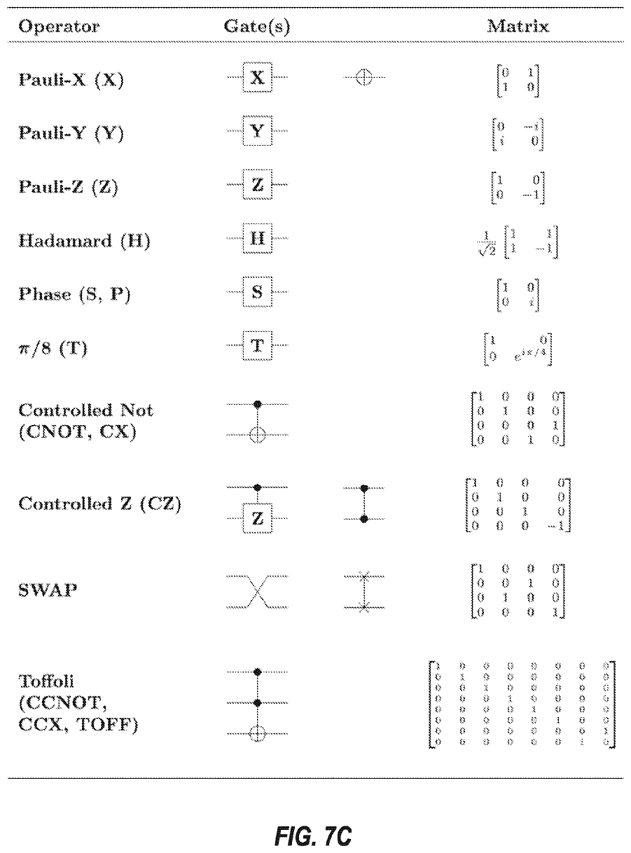

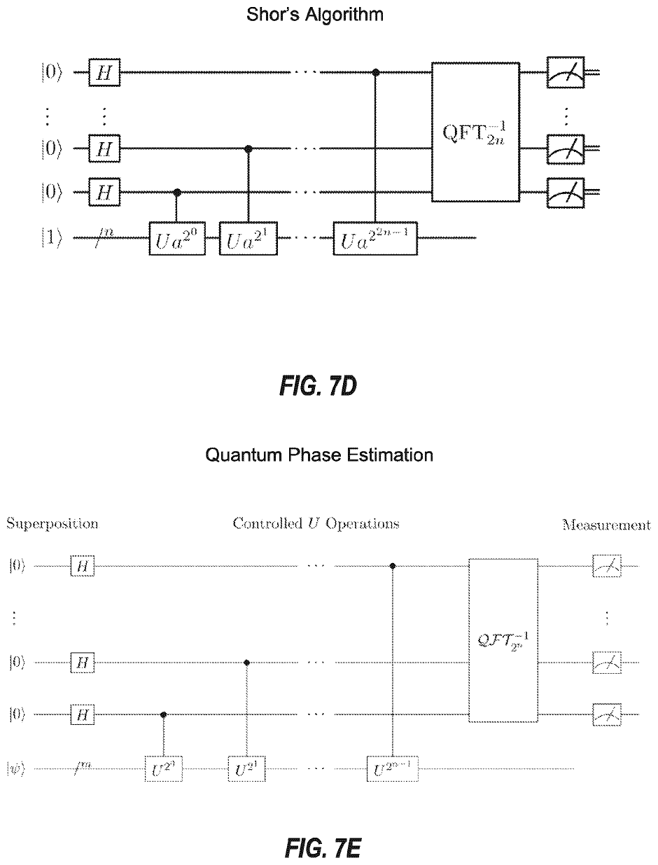

The methods and devices disclosed herein provide a universal gate set for quantum computing and thus can be used to perform any quantum computing algorithm. FIGS. 7A-7E illustrate various examples of quantum computing algorithms that can be performed using the universal gate set. For example, FIG. 7A illustrates a quantum half adder algorithm, which uses a Toffoli gate and a CNOT gate. FIG. 7B illustrates how the Toffoli gate can be decomposed into a series of single-qubit gates and two-qubit CNOT gates. The single-qubit gates include the Hadamard gate, which is discussed above as being implemented using a waveplate, and the T gate is simply a phase delay gate. FIG. 7C provides descriptions for the various gates. Thus, it is clear that the quantum half adder algorithm illustrated in FIG. 7A can be performed using the universal gate set disclosed herein.

FIGS. 7D and 7E illustrate circuit diagrams of Shor's algorithm and the phase estimation algorithm, respectively. Shor's algorithm is used for finding the prime factors of an integer, which has applications to cryptography and cryptology. The controlled unitary operations can be implemented using the universal gate set disclosed herein. Additionally, the quantum inverse Fourier transform can also be performed using the universal gate set disclosed herein.

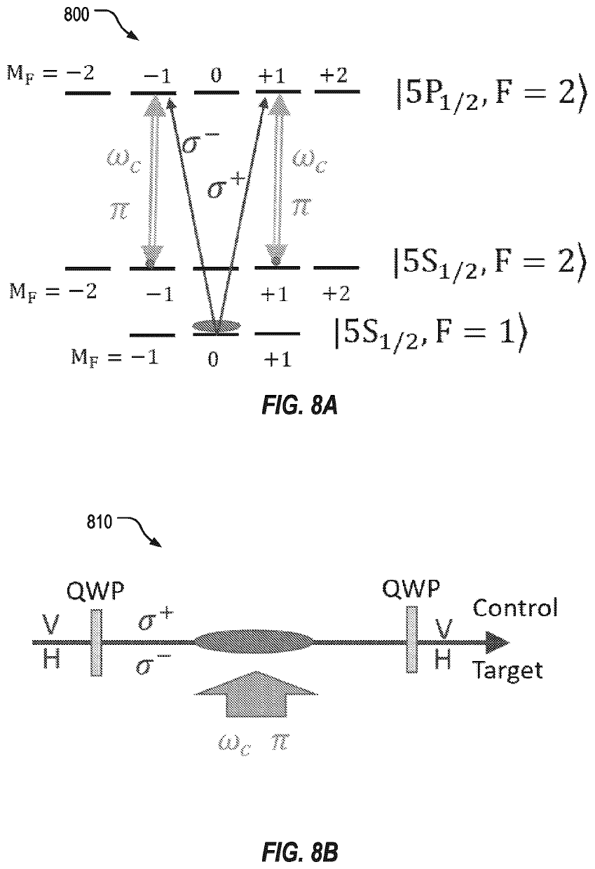

FIG. 8A illustrates an example of implementing the methods disclosed herein in an existing atomic system 800. Realization of the CP gate of the second architecture 200 uses two incoming modes of the control and target qubit photons to overlap spatially inside the single QM atomic ensemble. These two modes can be two orthogonal polarizations of photons, as shown in FIG. 2A. This can be implemented using a scheme with degenerate atomic Zeeman states 800. FIG. 8A shows an EIT atomic energy level diagram of ⁸⁷Rb D₁ transitions, which is used for a CP gate having the second architecture 200 with the same polarization but two different momentum modes. FIG. 8A shows an EIT atomic energy level diagram that takes ⁸⁷Rb D₁ transitions as an example. This scheme can be illustrated that the dual EIT channels in FIG. 8A with the Zeeman states 800 of hyperfine energy levels |5S_{1/2}, F=1 [symbol] , |5S_{1/2}, F=2 [symbol] , and |5P_{1/2}, F=2 [symbol] . The atomic ensemble is prepared in the ground state |5S_{1/2}, F=1, M_{F}=0 [symbol] by optical pumping. The control beam (ω_{c}) with linear π polarization resonantly dresses the two levels |5S_{1/2}, F=2 [symbol] and |5P_{1/2}, F=2 [symbol] , and the control beam captures the two EIT transition channels. The control qubit photon with circular polarization σ⁺ follows the EIT transition M_{F}=0↔+1↔+1, and the target qubit photon with circular polarization σ⁻ follows the EIT transition M_{F}=0↔−1↔−1. As these two EIT transitions are degenerate, a single Rydberg excitation pulse with a proper polarization works for both control and target photonic polarization modes.

FIG. 8B shows the optical setup 810 where a QWP is used to convert the two linear polarizations to two circular polarizations, and a second QWP converts the circular polarizations back to linear polarizations.

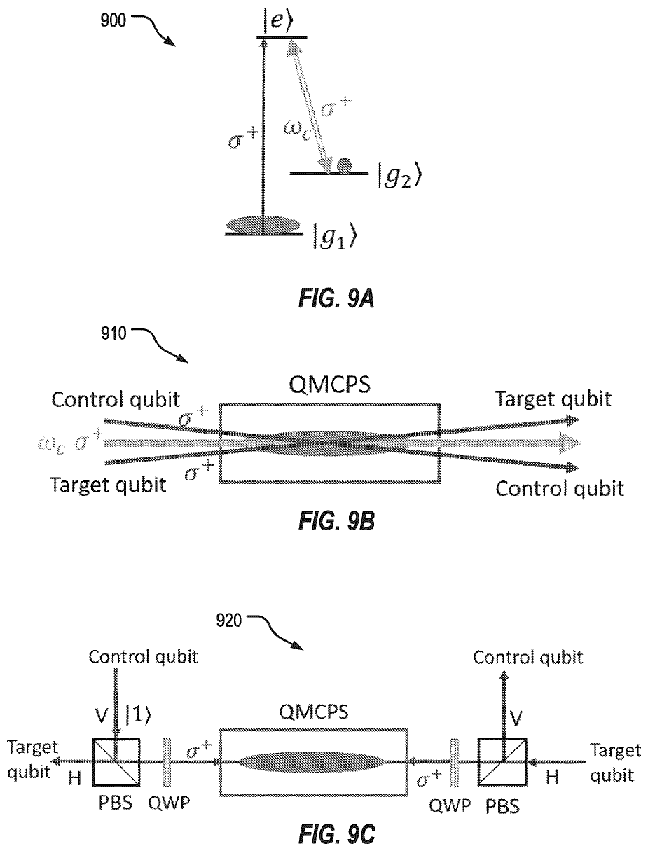

FIGS. 9A-9C illustrate another approach that used two momentum modes for the spatially overlapped control and target qubit photons. For example, as shown in the level diagram 900 of FIG. 9A, both qubit photons are σ⁺ circularly polarized and on resonance to transition |g₁ [symbol] ↔|e [symbol] . The control laser beam is on resonance to transition |g₂ [symbol] ↔|e [symbol] . FIG. 9B shows one solution of EIT optical setup with spatially overlapped control and target qubit modes sheared with a small angle. FIG. 9B shows an EIT forward optical setup 910 with spatially overlapped control and target qubit modes sheared with a small angle. Alternatively, these two momentum modes can propagate oppositely so that they can overlap maximally in space, as shown in FIG. 9C, where two QWPs are used to convert linear polarizations into circular polarizations, and two PBSs are used to separate the two polarizations. FIG. 9C shows an EIT backward optical setup 920 with control and target qubit modes propagating in opposite directions. During the operation of QM, the photonic momentum information is stored in the spatially varying phase of the atomic spin wave. Demonstrations indicate that a QM efficiency of >85% is achievable for single-photon polarization qubits encoded in dual momentum modes.

Now theoretical models are discussed for computing the state and gate efficiency and fidelity in presence of the QM loss. The results clearly display a significant difference between the photonic and other quantum computing platforms on performance. Specifically, for the superconducting, trapped-ion, and atom-array systems, their gate fidelities depend strongly on the decoherence as it brings a pure qubit state into a mixed state. In contrast, in the photon-atom hybrid system, the coupling between the qubit Hilbert space and the environment appears only when photon loss occurs in QM. However, these lost photons vanish into the environment and fail to be detected by single-photon counters. As a result, the QM loss has little impact on the fidelity of interest, but it does reduce the state generation efficiency greatly as a cost.

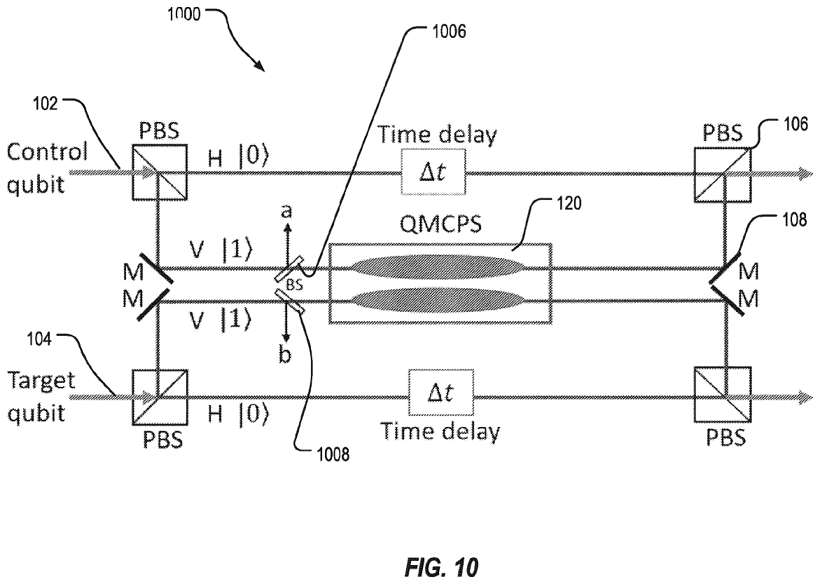

The QM loss model 1000 in FIG. 10 models the QM loss via a beam-splitter model by artificially adding two ancilla output channels, i.e., channel a 1006 and channel b 1008, to expand the Hilbert space of the output states, rather than resorting to the mixed states that are based on the same computational space as those in other platforms. In this model, except for the QM loss, any other errors are omitted because those errors can be controlled quite well by the state-of-the-art linear optical technologies hence poses no fundamental limit.

The ideal output state is denoted without QM loss as |φ₁ [symbol] . In presence of optical loss to the environment, the output state with an enlarged Hilbert space takes the form of

$$\vert {φ}_{2}^{′} 〉 = {c}_{2} \vert {φ}_{2} 〉 + {c}_{2 ⊥} \vert {φ}_{2 ⊥} 〉 ,$$

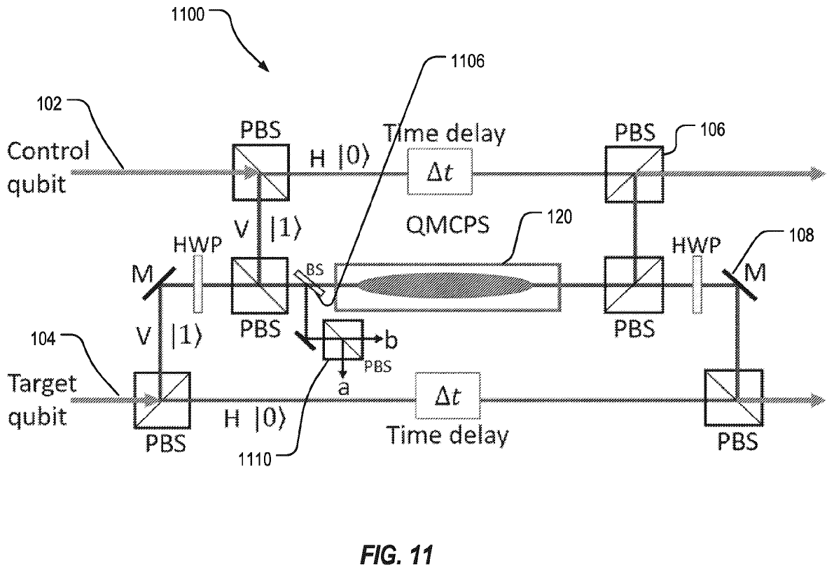

with |φ₂ [symbol] falling inside the computational Hilbert space and |φ_{2⊥} [symbol] outside by addressing photon loss through channels a 1006 and b 1008. In FIG. 11 the loss is modeled by the beam splitter (BS) 1106 and the polarizing beam splitter 1110, which also provides the two channels a and b. based on the above equation, it becomes apparent that [symbol] φ₂|φ_{2⊥} [symbol] =0 and c₂ and c_{2⊥} satisfy the normalization condition |c₂|²+|c_{2⊥}|²=1. These two ancilla output channels, a and b, do not exist physically, but are for mathematical modeling purpose only. The measurable state |φ₂ [symbol] is “post-selected” within the computational space. The state fidelity is computed as

$${F}_{12} = {\vert 〈 {φ}_{2} \vert {φ}_{2 ⊥} 〉 \vert}^{2} .$$

The generation efficiency E of the output state, i.e., the probability of keeping photons within the computational Hilbert space, is simply

$$E = {\vert {c}_{2} \vert}^{2} .$$

To evaluate the gate performance, the gate fidelity is computed by taking average of the state fidelity over all possible inputs |ψᵢₙ [symbol] as

$${F}_{Gate} = \overline{{\vert 〈 {φ}_{1} \vert {φ}_{2} 〉 \vert}^{2}} = {〈 {\vert 〈 {ψ}_{in} \vert {Gate}_{1}^{†} \cdot {Gate}_{2} \vert {ψ}_{in} 〉 \vert}^{2} 〉}_{\{ \vert {ψ}_{in} 〉 \}} .$$

Here, Gate₁ (Gate₂) stands for stands for the ideal (realistic) gate operation, and t means the operation of a conjugate transpose.

TABLE 2

| Input states | States after BS |
|---|---|
| \|HH [symbol] | \|1_{H}1_{H}0ₐ0_{b} [symbol] = \|HH [symbol] |
| \|HV [symbol] | $\sqrt{η} \vert {1}_{H} {1}_{V} {0}_{a} {0}_{b} 〉 + \sqrt{1 - η} \vert {1}_{H} {0}_{V} {0}_{a} {1}_{b} 〉 = \sqrt{η} \vert HV 〉 + \sqrt{1 - η} \vert {1}_{H} {0}_{V} {0}_{a} {1}_{b} 〉$ |
| \|VH [symbol] | $\sqrt{η} \vert {1}_{V} {1}_{H} {0}_{a} {0}_{b} 〉 + \sqrt{1 - η} \vert {0}_{V} {1}_{H} {1}_{a} {0}_{b} 〉 = \sqrt{η} \vert VH 〉 + \sqrt{1 - η} \vert {0}_{V} {1}_{H} {1}_{a} {0}_{b} 〉$ |
| \|VV [symbol] | $η \vert {1}_{V} {1}_{V} {0}_{a} {0}_{b} 〉 + \sqrt{η ( 1 - η )} \vert \sqrt{1 - η} \vert {1}_{V} {0}_{V} {0}_{a} {1}_{b} 〉 + \sqrt{η ( 1 - η )} \vert {0}_{V} {1}_{V} {1}_{a} {0}_{b} 〉 + ( 1 - η ) \vert {0}_{V} {0}_{V} {1}_{a} {1}_{b} 〉 = η \vert VV 〉 + \sqrt{η ( 1 - η )} \vert {1}_{V} {0}_{V} {0}_{a} {1}_{b} 〉 + \sqrt{η ( 1 - η )} \vert {0}_{V} {1}_{V} {1}_{a} {0}_{b} 〉 + ( 1 - η ) \vert {0}_{V} {0}_{V} {1}_{a} {1}_{b} 〉$ |

For OP gate of the first architecture 100, the loss is modeled by inserting an η: 1−η non-symmetric beam splitter (BS) with transmittance η and reflectance 1−η in front of each QM. For simplicity, it is assumed that the input photon with the H-polarization does not experience loss; but for the V-polarized input photon, there will be the probability of 1−η to be reflected to two ancilla output channels a and b without being detected.

Similarly, for CP gate of the second architecture 200, the loss is modeled by inserting an η: 1−η non-symmetric BS in front of the common QM followed by a PBS and then perform the same analysis. Note that here the QM efficiency has already been replaced by the transmittance η.

After some straightforward linear algebra, the states are tabulated after the BS for different input states in Table 2. As shown, the QM loss of the CP gate introduces 5 additional bases orthogonal to the ideal computational basis {|1ᵢ1ⱼ0ₐ0_{b} [symbol] } (i, j=H, V), thereby inevitably enlarging the Hilbert space. Thanks to the post-selection (i.e., single-photon detection), the Hilbert space can be reduced to the computational space. Consequently, the CP gate with loss is now characterized by the following nonunitary matrix (in the computational basis),

$${CP}_{2} = [ \begin{matrix}1 & 0 & 0 & 0 \\ 0 & - 1 & 0 & 0 \\ 0 & 0 & - 1 & 0 \\ 0 & 0 & 0 & - 1\end{matrix} ] [ \begin{matrix}1 & 0 & 0 & 0 \\ 0 & \sqrt{η} & 0 & 0 \\ 0 & 0 & \sqrt{η} & 0 \\ 0 & 0 & 0 & \sqrt{η}\end{matrix} ] = [ \begin{matrix}1 & 0 & 0 & 0 \\ 0 & - \sqrt{η} & 0 & 0 \\ 0 & 0 & - \sqrt{η} & 0 \\ 0 & 0 & 0 & - \sqrt{η}\end{matrix} ]$$

The single-quit phase gate P

$$( - \frac{π}{2} )$$

and rotation gate X(π/2), as discussed above in the main text. One can readily obtain the matrix of the realistic CNOT gate as follows:

$${CNOT}_{2} = P ( - \frac{π}{2} ) \cdot X ( \frac{π}{2} ) \cdot {CP}_{2} \cdot X ( \frac{π}{2} ) \cdot P ( - \frac{π}{2} ) .$$

Note that the CP₂ and CNOT₂ gate operations are not unitary in presence of loss (η<1). This is due to the optical losses that introduce additional dimensions to the Hilbert Space. In the extended Hilbert space, where the losses are modeled as outputs a and b with non-symmetric beam splitters, the entire gate operations are still unitary, but their projections to the computational basis are nonunitary. As measuring only in the computational basis, the projected CP₂ and CNOT₂ gates are taken as nonunitary operations.

It is noted that the ideal CNOT gate operation should be read as

$${CNOT}_{1} = [ \begin{matrix}1 & 0 & 0 & 0 \\ 0 & 1 & 0 & 0 \\ 0 & 0 & 0 & 1 \\ 0 & 0 & 1 & 0\end{matrix} ] .$$

In presence of optical loss to the environment, for a given input state

$$\vert {φ}_{i n} 〉 = {a}_{H H} \vert HH 〉 + {a}_{H V} \vert HV 〉 + {a}_{V H} \vert VH 〉 + {a}_{V V} \vert VV 〉 .$$

The output state in the enlarged Hilbert space is

$$\vert {φ}_{2}^{′} 〉 = {CNOT}_{2} \vert {φ}_{i n} 〉 + {a}_{H V} \sqrt{1 - η} \vert {1}_{H} {0}_{V} {0}_{a} {1}_{b} 〉 + {a}_{V H} \sqrt{1 - η} \vert {0}_{V} {1}_{H} {1}_{a} {0}_{b} 〉 + {a}_{VV} [ [ \sqrt{η ( 1 - η )} \vert {1}_{V} {0}_{V} {0}_{a} {1}_{b} 〉 + \sqrt{η ( 1 - η )} \vert {0}_{V} {1}_{V} {1}_{a} {0}_{b} 〉 + ( 1 - η ) \vert {0}_{V} {0}_{V} {1}_{a} {1}_{b} 〉 ] = {c}_{2} \vert {φ}_{2} 〉 + {c}_{2 ⊥} \vert {φ}_{2 ⊥} 〉$$

where |φ₂ [symbol] after renormalization in the computational basis is

$$\vert {φ}_{2} 〉 = \frac{{CNOT}_{2} \vert {φ}_{i n} 〉}{\sqrt{〈 {φ}_{i n} \vert {CNOT}_{2}^{†} \cdot {CNOT}_{2} \vert {φ}_{i n} 〉}}$$

$$its efficiency is$$

$${\vert {c}_{2} \vert}^{2} = 〈 {φ}_{i n} \vert {CNOT}_{2}^{†} \cdot {CNOT}_{2} \vert {φ}_{i n} 〉 .$$

Different input states will result in different gate efficiencies and fidelities. Therefore, a more meaningful metric is the average of the efficiency (fidelity) over all possible input states |φᵢₙ [symbol] . To this end, it is noted that the average gate efficiency and fidelity of the realistic CNOT gate to be

$${E}_{CNOT} = {〈 \vert {c}_{2} {\vert}^{2} 〉}_{\{ \vert {φ}_{i n} 〉 \}} ,$$

$$and$$

$${F}_{C N O T} = {〈 \frac{\vert 〈 {φ}_{i n} \vert {CNOT}_{1}^{†} \cdot {CNOT}_{2} \vert {φ}_{i n} 〉 {\vert}^{2}}{〈 {φ}_{i n} \vert {CNOT}_{2}^{†} \cdot {CNOT}_{2} \vert {φ}_{i n} 〉} 〉}_{\{ \vert {φ}_{i n} 〉 \}} ,$$

respectively, where CNOT₁ and CNOT₂ are given above.

Because it is not easy to divide the Hilbert space evenly by including the two-qubit interaction, in the numerical simulations the states are randomly selected from the overall Hilbert space as samples so as to calculate the average gate fidelity and efficiency. By ignoring the total phase, the input two-qubit state is written as |φᵢₙ [symbol] =[a₁,a₂e^{iϕ}^{₂},a₃e^{iϕ}^{₃},a₄e^{iϕ}^{₄}] with aⱼ being the amplitude and ϕⱼ∈[0,2π] being the relative phase.

Note that the CNOT gate fidelity and efficiency are not zero when η=0. This is because the input H-polarized photons undergo perfect propagation in the assumption. Therefore, theoretically one should get F_{CNOT}=E_{CNOT}=0.25 for η=0.

Now a derivation is presented for the generation of an N-qubit GHZ state. As illustrated in FIG. 4A, since the Hadamard gate only operates on the first qubit, the input two-qubit state after the first CNOT gate becomes η|φₒᵤₜ [symbol] =1/\sqrt{2}(|00 [symbol] +|11 [symbol] ) in the ideal scenario. By further extending to qubit 3, according to FIG. 4A, the overall output state to be |φₒᵤₜ [symbol] ₁₃₂=1/\sqrt{2}(|000)+|111 [symbol] ), which is a tripartite GHZ state. If continuing to repeat the procedure, one can readily show that for N qubit inputs, the circuit is able to deliver an N-partite GHZ state |GHZ₁ [symbol] =1/\sqrt{2}(|0 [symbol] ^{⊗N}+|1 [symbol] ^{⊗N}).

For an imperfect CNOT gate (due to photon loss in the CP gate in schemes 1 and 2), however, its operation on the two components |00 [symbol] and |10 [symbol] will lead to different outputs. Specifically,

$$\begin{matrix}{CNOT}_{2} \vert 00 〉 = 1 / 2 [ ( 1 + \sqrt{η} ) \vert 00 〉 + ( - 1 + \sqrt{η} ) \vert 01 〉 ] \\ {CNOT}_{2} \vert 10 〉 = 1 / 2 [ ( - \sqrt{η} + η ) \vert 10 〉 + ( \sqrt{η} + η ) \vert 11 〉 ]\end{matrix}$$

With these in mind, by following the quantum circuit diagram of FIG. 4(a) in the main text, one can show that the overall state of three input qubits, after the Hadamard gate and the first CNOT gate, takes the form of

$${{{{{\vert {φ}_{i n} 〉}_{132} = \frac{1}{2 \sqrt{2}} ( \vert 00 〉}_{13} ⊗ \vert {Φ}_{1} 〉}_{2} + \vert 10 〉}_{13} ⊗ \vert {Φ}_{2} 〉}_{2} ) ,$$

where |Φ₁ [symbol] =(1+\sqrt{η})|0 [symbol] +(−1+\sqrt{η})|1 [symbol] and |Φ₂ [symbol] =(−η+η)|0 [symbol] +(\sqrt{η}+η)|1 [symbol] . As the second CNOT gate only operates on qubits 1 and 3, this will further change the state |φᵢₙ [symbol] ₁₃₂ into

$${{{{{\vert {φ}_{out} 〉}_{132} = \frac{1}{{2}^{2} \sqrt{2}} ( \vert 0 〉}_{1} ⊗ \vert {Φ}_{1} {Φ}_{1} 〉}_{32} + \vert 1 〉}_{1} ⊗ \vert {Φ}_{2} {Φ}_{2} 〉}_{32} ) .$$

Extending to N qubits, by recursion, one can attain an output N-partite GHZ state with loss as following,

$${{{{{\vert GH {Z}_{2} 〉}_{N} = \frac{1}{{2}^{N - 1} \sqrt{2}} ( \vert 0 〉}_{1} ⊗ \vert {Φ}_{1} 〉}^{⊗ ( N - 1 )} + \vert 1 〉}_{1} ⊗ \vert {Φ}_{2} 〉}^{⊗ ( N - 1 )} ) .$$

The efficiency of producing such an N-qubit GHZ state in reality turns out to be

$$E ( N ) = {〈 G H {Z}_{2} \vert GH {Z}_{2} 〉}_{N} = \frac{1 + {η}^{N - 1}}{{2}^{2 N - 1}} {\sum }_{m = 0}^{N - 1} P ( m )$$

and the renormalized fidelity is

$${F}_{12} ( N ) = \frac{\vert {〈 GH {Z}_{1} \vert GH {Z}_{2} 〉}_{N} {\vert}^{2}}{{〈 G H {Z}_{2} \vert GH {Z}_{2} 〉}_{N}} = \frac{{[ {( 1 + \sqrt{η} )}^{N - 1} + {( \sqrt{η} + η )}^{N - 1} ]}^{2}}{2 ( 1 + {η}^{N - 1} ) {\sum }_{m = 0}^{N - 1} P ( m )} ,$$

where |GHZ₁ [symbol] is the aforementioned ideal GHZ state, and

$$P ( m ) = {{C}_{N - 1}^{m} [ {( 1 + \sqrt{η} )}^{m} {( - 1 + \sqrt{η} )}^{N - 1 - m} ]}^{2} .$$

When N=3, one can use the matrix multiplication to directly obtain the output GHZ state and calculate the associated fidelity and efficiency.

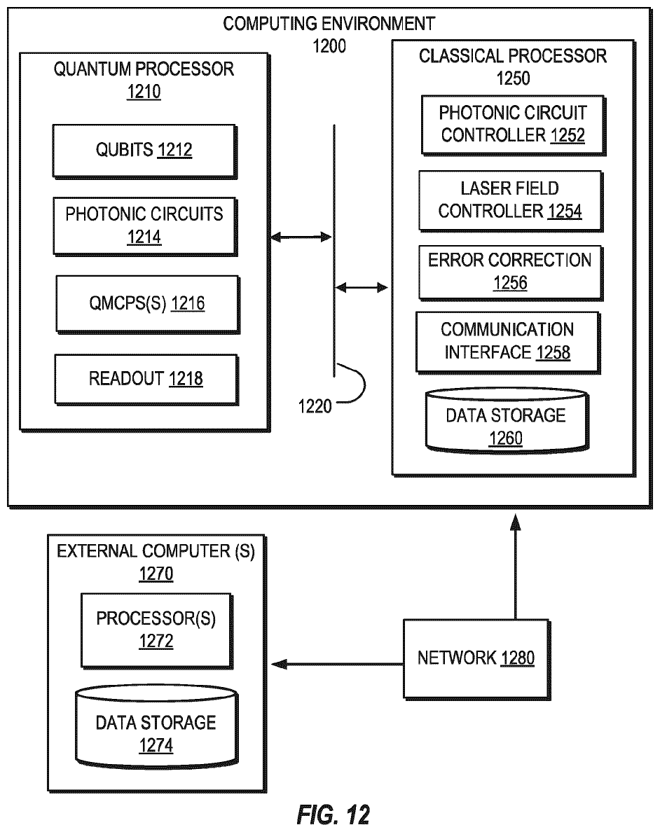

FIG. 12 illustrates, a non-limiting example of a system for implementing embodiments of the disclosed technology, which includes computing environment 1200. The computing environment 1200 includes a quantum processor(s) 1210 and one or more read-out device(s) 1218. The quantum processor(s) 1210 execute quantum circuits that are precompiled and described by the quantum computer circuit description. In addition to the readout device(s) 1218, the quantum processor(s) 1210 include qubits 1212, photonic circuits 1214 (or free-space optical elements), quantum memory control phase shift (QMCPS) devices 1216. The qubits 1212 can be the polarization states of respective photons. The photonic circuits 1214 can be waveguides, switches, and optical elements that functions as waveplates and other single-qubit gates for the polarization states of respective photons. The QMCPS devices 1216 can be atomic ensembles with laser fields (e.g., the control laser) for transferring the photonic quantum state to the atomic ensemble and realize a controlled phase gate operation via a Rydberg blockade.

The classical processor 1250 can include a photonic circuit controller 1252, a laser field controller 1254, an error correction processor 1256, a communication interface 1258, and a data storage 1260. The photonic circuit controller 1252 can control fiber optical switches, the angles of the waveplates, delay loops, and other aspects of the optical elements in the photonic circuits 1214. The laser field controller 1254 can control the intensity of the control laser and the laser for the Rydberg transition, for example. The error correction processor 1256 can perform error correction on the quantum states for the qubits. The data storage 1260 can store quantum algorithms that are executed using the quantum processor 1210. Further, the classical processor 1250 can be programmed to implement any of the disclosed quantum algorithms.

The classical processor 1250 (e.g., the photonic circuit controller 1252 and the laser field controller 1254) facilitates implementation of a compiled quantum algorithm/circuit by sending instructions to the quantum processor 1210 to perform a quantum algorithm. The classical processor 1250 can further interact with readout devices 308 to help control and implement the desired quantum computing process by reading or measuring out data results from the quantum processor 1210 once available.

With reference to FIG. 1200, compilation of the quantum algorithm is the process of translating a high-level description of a quantum algorithm into a quantum computer circuit description comprising a sequence of quantum operations or gates. The compilation can be performed by the classical processor 1250 which loads the high-level description from the data storage 1260 and stores the resulting quantum computer circuit description in the data storage 1260.

In other embodiments, compilation can be performed remotely by an external computer 1270, which is connected to the computing environment via a network 1280. The external computer 1270 includes processor(s) 1272 and a data storage 1274. The external computer 1270 can compile and store the resulting quantum computer circuit description in the data storage 1274 and transmits the quantum computer circuit description to the computing environment 1200 for implementation in the quantum processor 1210.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

1. A method to perform a quantum computing operation, the method comprising:
initializing a quantum memory (QM) including a plurality of atoms in a first quantum state of the QM;
mapping a photonic quantum state of a photon pair to the QM to cause the QM to transition from the first quantum state to a second quantum state, the photon pair including a first photon and a second photon that propagate along respective optical paths through the QM; and
inducing a phase shift on the second quantum state, the phase shift based on a Rydberg blockade and conditional on the photonic quantum state.

2. The method of claim 1,
wherein,
the first quantum state includes each of the plurality of atoms in a first ground state, and
the second quantum state includes an entangled state that is a superposition of states in which one of the plurality of atoms is in a second ground state with all other atoms of the plurality of atoms in the first ground state, when at least one photon of the photon pair has a first polarization.

3. The method of claim 2, further comprising:
inducing the phase shift by using the Rydberg blockade to induce the phase shift on a first set of atoms in a first optical path of the first photon or on a second set of atoms in a first optical path of the second photon,
wherein,
the first set of atoms and the second set of atoms are respective subsets of the plurality of atoms of the QM,
the second set of atoms is spaced from the first set of atoms, and
the second set of atoms is within a proximity to the first set of atoms to enable the Rydberg blockade between the second set of atoms and the first set of atoms.

4. The method of claim 3,
wherein the phase shift is induced by:
inducing a first Rabi oscillation on the first set of atoms, the first Rabi oscillation being induced from the second ground state to a Rydberg state using an Nπ pulse with N being an odd integer,
inducing a second Rabi oscillation on the second set of atoms, the second Rabi oscillation being induced between the second ground state and the Rydberg state, when the Rydberg state is not shifted due to the Rydberg blockade, using an 2Mπ pulse with M being an odd integer, and
inducing a third Rabi oscillation on the first set of atoms, the third Rabi oscillation induced from the Rydberg state to the second ground state using a Pπ pulse with P being an odd integer.

5. (canceled)

6. The method of claim 1, further comprising:
inducing the phase shift by inducing a Rabi oscillation on a set of atoms of the plurality of atoms,
wherein,
the set of atoms is in an optical path of both the first photon and the second photon, and
the Rabi oscillation is induced between the second ground state and a Rydberg state using an Nπ pulse with N being an even integer, such that, for both the first entangled state and the second entangled state, the Rabi oscillation concludes with a complete Rabi flopping cycle with the set of atoms substantially returning from the Rydberg state to the second ground state.

7. The method of claim 1,
wherein,
the photonic quantum state is encoded in respective polarizations of the first photon and the second photon,
a state of a control qubit is encoded in a polarization of the first photon, and
a state of a target qubit is encoded in a polarization of the second photon.

8. The method of claim 7,
wherein,
for each photon of the photon pair, a first polarization is sent along a first optical path through the QM and a second polarization is sent along a second optical path that circumvents the QM, and
the method further comprises recombining the first optical path and the second optical path to direct the first polarization and the second polarization along a same optical path for each photon of the photon pair, the first optical path and the second optical path recombined using a polarizing beam splitter (PBS).

9. The method of claim 8,
wherein,
the first optical path of the first photon overlaps the first optical path of the second photon.

10. The method of claim 8,
wherein,
the first optical path of the first photon is spaced from the first optical path of the second photon, and
the first optical path of the first photon is within a proximity to the first optical path of the second photon to enable the Rydberg blockade.

11. The method of claim 1,
wherein,
the mapping of the photonic quantum state to the QM is performed using electromagnetically induced transparency to couple the photonic quantum state with the QM.

12. The method of claim 1,
wherein,
a two-qubit controlled-phase (CP) gate operation is performed on the photon pair due to interactions with the QM to yield a conditional phase on the photon pair due to the interactions with the QM being conditional on the photonic quantum state.

13. The method of claim 12, further comprising:
converting the CP gate operation to a controlled-not (CNOT) gate operation by applying waveplates to the second photon before the QM and after the QM.

14. (canceled)

15. The method of claim 12, further comprising:
generating a Greenberger-Horne-Zeilinger (GHZ) state among a plurality of photons including a first photon and other photons, the first photon having a polarization that encodes a control qubit, the other photons having respective polarizations that encode corresponding target bits; and
using at least one QM to perform respective CNOT gate operations between the first photon and each of the other photons.

16. (canceled)

17. The method of claim 1, further comprising:
arranging the QMs to perform a quantum algorithm.

18. (canceled)

19. A quantum apparatus comprising:
a photon pair including a first photon and a second photon, the photon pair encoding a photonic quantum state in a first polarization of the first photon and in a second polarization of the second photon;
a quantum memory (QM) including a plurality of atoms initialized in a first quantum state of the QM, the QM including a first optical path of the first photon along which the first polarization of the first photon propagates and a first optical path of the second photon along which the second polarization of the second photon propagates; and
a controller configured to control a plurality of laser fields, the plurality of laser fields including a Rydberg field,
wherein the controller is configured to:
initialize the QM in a first quantum state,
map the photonic quantum state of the photon pair to the QM to cause the QM to transition from the first quantum state to a second quantum state, and
induce a phase shift on the second quantum state, the phase shift based on a Rydberg blockade and conditional on the photonic quantum state.

20. The quantum apparatus of claim 19,
wherein,
the first quantum state includes each of the plurality of atoms in a first ground state, and
the second quantum state includes an entangled state that is a superposition of states in which one of the plurality of atoms is in a second ground state with all other atoms of the plurality of atoms in the first ground state, when at least one photon of the photon pair has the first polarization.

21. The quantum apparatus of claim 20,
wherein,
the controller is configured to induce the phase shift by using the Rydberg blockade to induce the phase shift on a first set of atoms in the first optical path of the first photon or on a second set of atoms in the first optical path of the second photon,
the first set of atoms and the second set of atoms are respective subsets of the plurality of atoms of the QM,
the second set of atoms is spaced from the first set of atoms, and
the second set of atoms is within a proximity to the first set of atoms to enable the Rydberg blockade between the second set of atoms and the first set of atoms.

22. The quantum apparatus of claim 21,
wherein the controller is configured to induce the phase shift by:
inducing a first Rabi oscillation on the first set of atoms, the first Rabi oscillation being induced from the second ground state to a Rydberg state using an Nπ pulse with N being an odd integer,
inducing a second Rabi oscillation on the second set of atoms, the second Rabi oscillation being induced between the second ground state and the Rydberg state, when the Rydberg state is not shifted due to the Rydberg blockade, using a 2Mπ pulse with M being an odd integer, and
inducing a third Rabi oscillation on the first set of atoms, third Rabi oscillation induced from the Rydberg state to the second ground state using a Pπ pulse with P being an odd integer.

23. (canceled)

24. The quantum apparatus of claim 19,
wherein,
the controller is configured to induce the phase shift by inducing a Rabi oscillation on a set of atoms of the plurality of atoms,
the set of atoms is in an optical path of both the first photon and the second photon, and
the Rabi oscillation is induced between the second ground state and a Rydberg state using an Nπ pulse with N being an even integer, such that, for both the first entangled state and the second entangled state, the Rabi oscillation concludes with a complete Rabi flopping cycle with the set of atoms substantially returning from the Rydberg state to the second ground state.

25. The quantum apparatus of claim 19,
wherein,
the photonic quantum state is encoded in respective polarizations of the first photon and the second photon,
a state of a control qubit is encoded in a polarization of the first photon, and
a state of a target qubit is encoded in a polarization of the second photon.

26. The quantum apparatus of claim 19,
wherein,
for each photon of the photon pair, the first polarization is sent along the first optical path through the QM and the second polarization is sent along a second optical path that circumvents the QM.

27. The quantum apparatus of claim 19,
wherein,
the first optical path of the first photon overlaps the first optical path of the second photon.

28. The quantum apparatus of claim 21, further comprising:
a first polarizing beam splitter (PBS) operable to recombine the first optical path of the first photon and a second optical path of the first photon; and
a second PBS operable to recombine the first optical path of the second photon and a second optical path of the second photon.

29. The quantum apparatus of claim 26,
wherein,
the first optical path of the first photon is spaced from the first optical path of the second photon; and
the first optical path of the first photon is within a proximity to the first optical path of the second photon to enable the Rydberg blockade.

30. The quantum apparatus of claim 19,
wherein,
the controller is configured to map the photonic quantum state to the QM using electromagnetically induced transparency.

31. The quantum apparatus of claim 19,
wherein,
the quantum apparatus is configured to perform a two-qubit controlled-phase-(CP) gate operation on the photon pair using interactions with the QM, resulting in a conditional phase on the photon pair due to said interactions with the QM being conditional on a two-qubit quantum state of the photon pair.

32. The quantum apparatus of claim 31,
wherein,
the quantum apparatus is configured to perform a two-qubit controlled-not (CNOT) gate operation by applying waveplates to the second photon before the QM and after the QM.

33. (canceled)

34. The quantum apparatus of claim 19,
wherein the quantum apparatus is configured to:
generate a Greenberger-Horne-Zeilinger (GHZ) state among a plurality of photons comprising a first photon and other photons, the first photon having a polarization that encodes a control qubit, the other photons having respective polarizations that encode corresponding target bits, and
use one or more QMs to perform respective CNOT gate operations between the first photon and each of the other photons.

35. A quantum system comprising:
a plurality of the QMs of claim 19; and
photonic pathways arranged among the plurality of the QMs, wherein the photonic pathways comprise photonic circuits and or free-space optics and comprise waveplates in one or more of the photonic pathways.

36. (canceled)

37. The quantum system of claim 35,
wherein,
the photonic pathways are arranged among the plurality of the QMs to perform a quantum algorithm.

38.-39. (canceled)
